(19) United States
(12) Patent Application Publication
(10) Pub. No.: US 2008/0049934 A1
(43) Pub. Date: Feb. 28, 2008

(54) Management Server Device, Content Repoduction Device, and Recording Medium

(76) Inventors: Senichi Onoda, Osaka (JP); Masaya Yamamoto, Arcadia (CA)

Correspondence Address: WENDEROTH, LIND & PONACK L.L.P., 2033 K. STREET, NW, SUITE 800, WASHINGTON, DC, 20006, US

(21) Appl. No.: 11/792,928

(22) PCT Filed: Dec. 9, 2005
(86) PCT No.: PCT/JP05/22672

§ 371 Date: Jun. 13, 2007

(30) Foreign Application Priority Data
Dec. 14, 2004 (JP) 2004-361843

(51) Int. Cl. H04N 7/167; H04L 9/00

(52) U.S. Cl. 380/201; 380/45

(57) ABSTRACT

When a technique for specifying an unauthorized terminal based on a combination of watermarks embedded in content distributed without authorization is applied to content distributed on recording media, recording capacity limits of the recording media lead to a limit on the number of combinations of watermarks that can be embedded in the content, and only a limited number of terminals can be specified. In the present invention, all terminals are sorted into the same number of groups as there are combinations of watermarks, and a group that includes an unauthorized terminal can be specified based on the combination of watermarks embedded in the content. When the group including the unauthorized terminal is specified, this group is divided into groups, and a plurality of groups that do not include the unauthorized terminal are integrated. This enables the unauthorized terminal to be specified while keeping within the capacity of the recording medium.

### TECHNICAL FIELD

The present invention relates to a technique for preventing unauthorized usage of digital content.

### BACKGROUND ART

With increases in capacity of storage media in recent years, systems that distribute contents, which are copyrighted works such as movies, that have been digitized and stored on media such as digital optical discs are becoming common.

In such a distribution system, it is necessary to protect the copyright of content such that playback, copying and the like of the content is carried out only under limitations defined by an agreement with the copyright holder. This kind of distribution system for protecting copyrighted works from unauthorized copying and the like, in other words copying and the like without the permission of the copyright holder, has a structure whereby digital content is encrypted with a content key managed by the copyright holder, recorded on a disc, and is only able to be decrypted by a terminal that has a corresponding content key. A party wishing to obtain the content key must obey stipulations relating to copyright protection agreed on with the copyright holder.

However, even with this kind of structure, it is possible that a malicious user will hack a terminal, and therefore it cannot be guaranteed that the unauthorized distribution of content will be prevented completely. To deal with this, techniques such as that disclosed by Patent Document 1 have been proposed that specify a terminal apparatus that is the source of distribution based on content distributed without authorization.

With this technique, content is divided into a plurality of sections, and variations of some of the sections are prepared that each have unique information embedded therein as a watermark. Here, different versions that have different embedded watermarks are prepared with respect to the plurality of data sections of the content, and the order in which the data sections are played is designated such that no combination is shared by any two terminal apparatuses. As a result, the combination of watermark information embedded in the content played is different for each playback apparatus, and therefore a terminal apparatus that is a source of unauthorized distribution of the content can be specified from the unauthorized content.

Patent Document 1: US Patent Application Publication No. 2004/0111611

### DISCLOSURE OF THE INVENTION

### Problem to be Solved by the Invention

However, when distributing content using recording media such as BDs (Blu-ray Discs), it is difficult to fit all variations of content data for all terminal apparatuses onto each recording medium when an enormous number of terminal apparatuses exist. For this reason, there is a problem that the technique disclosed by Patent Document 1 cannot be applied, and a terminal that is the source of distribution of unauthorized content cannot be specified from the unauthorized content.

In view of this problem, an object of the present invention is to provide a management server apparatus, a recording medium generation apparatus, a recording medium, a content playback apparatus, a management method, a management program, a content playback method, and a playback program that allow variations of content data to be recorded on a single recording medium, and also enable a terminal apparatus that distributed without authorization to be specified.

### Means to Solve the Problem

In order to solve the stated problem, the present invention is a management server apparatus that manages one or more terminal apparatuses associated with unauthorized usage with use of a plurality of groups to which a plurality of terminal apparatuses belong, the management server apparatus including: a holding unit operable to hold the plurality of groups to which the one or more terminal apparatuses belong; an acquisition unit operable to acquire a designation of a target group to which the terminal apparatus associated with unauthorized usage belongs; a division unit operable to divide the designated target group into (i) a divisional group to which the terminal apparatus associated with unauthorized usage belongs, and (ii) at least one divisional group to which a remaining terminal apparatus of the target group belongs; a selection unit operable to select two or more candidate groups to which the terminal apparatus associated with unauthorized usage does not belong; and an integration unit operable to integrate the selected candidate groups.

### EFFECTS OF THE INVENTION

According to the stated structure, by dividing the target group to which the terminal apparatus associated with unauthorized usage belongs, the terminal apparatus associated with unauthorized usage can be specified easily. Furthermore, by integrating candidate groups excluding the target group, the overall number of groups will at least be no greater than before the integration. Therefore, variations of the content are able to be recorded on one recording medium.

Here, the selection unit may select the candidate groups such that at least one of the candidate groups includes terminal apparatuses whose total number is less than a predetermined number.

According to the stated structure, groups that have less terminal apparatuses belonging thereto than a predetermined number are selected as the candidate groups that are the target of integration. Therefore, the number of terminal apparatuses belonging to the groups after integration can be limited. If the number of terminal apparatuses belonging to the groups is relatively low, it is easier to discover a terminal apparatus relating to illegal usage.

Here, the selection unit may select the candidate groups that have mutual relation with each other.

According to the stated structure, candidate groups that are mutually related to each other are selected as the candidate groups that are the target of integration, and therefore the groups can be managed more easily after integration.

Here, the integration unit may integrate the selected candidate groups such that a total number of resultant one or more integrated groups is lower than a total number of the selected candidate groups.

According to the stated structure, the selected candidate groups are integrated such that the generated integrated groups are fewer in number. Therefore, the overall number of groups after integration is at least no greater than before integration.

Here, the holding unit may hold the plurality of groups of the terminal apparatuses that have been sorted with use of a tree structure.

According to the stated structure, the plurality of terminal apparatuses are sorted with use of a tree structure, and therefore even if the number of terminal apparatuses becomes enormous, the amount of management information for sorting can be kept to a realistic amount.

Here, the tree structure may be composed of a plurality of nodes arranged in a multi-layer tree shape, each of the terminal apparatuses may be allocated to a different one of leaves in the tree structure, and in any given subtree in the tree structure, terminal apparatuses allocated to leaves thereof may compose a single group, a subtree being a portion of the tree structure whose root is a given node in the tree structure, the division unit, for each of a plurality of subtrees whose root is a subordinate of a target node corresponding to the target group, a divisional group including one or more terminal apparatuses, each of the terminal apparatuses being allocated to a leaf of the subtree, and replaces the target group with the generated divisional groups, the selection unit may select a plurality of subordinate nodes that are subordinate to a superordinate node of the target node and exclude the target node, and select candidate groups corresponding to each of the selected subordinate nodes, and the integration unit may integrate the selected candidate groups into one integrated group.

According to the stated structure, the target group can be reliably divided and the candidate groups can be reliably integrated using the tree structure.

Here, the holding unit may store a plurality of mutually different decryption keys, each corresponded with a different one of the groups, the division unit, instead of a decryption key of the designated target group, may generate a decryption key for the divisional group to which the terminal apparatus associated with unauthorized usage belongs, and generate a different decryption key for the divisional group to which the remaining terminal of the target group belongs, the selection unit may select a different decryption key for each candidate group, and the integration unit may generate one decryption key to correspond to the integrated group instead of the different decryption keys for the candidate groups.

According to the stated structure, since each group has different decryption keys, the usage of content can be restricted according to group.

Furthermore, the present invention is a recording medium writing apparatus that writes encrypted content to a recording medium, including: a media key generation unit operable to generate a media key that includes a portion unique to the recording medium and a portion unique to a content playback apparatus; a media key encryption unit operable to encrypt said media key with use of a device key allocated to said content playback apparatus, thereby generating an encrypted media key; a control unit operable to generate a media key set composed of a plurality of encrypted media keys, the plurality of encrypted media keys being generated by the control unit (a) controlling the media key generation unit so as to generate a media key for each of the plurality of playback apparatuses, and (b) controlling the media key encryption unit so as to generate an encrypted media key for each of the plurality of playback apparatuses; a clip key encryption unit operable to encrypt a tracing clip key with use of said media key, thereby generating an encrypted tracing clip key; a content generation unit operable to (a) encrypt a tracing clip with use of the tracing clip key, thereby generating an encrypted tracing clip, the tracing clip having tracing information embedded therein as a digital watermark, and (b) generate encrypted content that includes the generated encrypted tracing clip in correspondence with said content playback apparatus; and a writing unit operable to write the generated media key set, the encrypted tracing clip data, and the encrypted content to the recording medium.

According to the stated structure, since a media key composed of a portion unique to the recording medium and a portion unique to the playback apparatus is generated, a recording medium can be generated that allows content to be decrypted only with a combination of a specific content playback apparatus and a specific recording medium.

Furthermore, the present invention is a computer-readable portable recording medium storing thereon a media key set that is in correspondence with a content playback apparatus and that includes an encrypted media key generated by encrypting a media key with use of a device key, the media key includes a portion unique to the recording medium and a portion unique to the content playback apparatus, and the device key being a device key allocated to the content playback apparatus, an encrypted tracing clip key generated by encrypting tracing clip key with use of the media key, and encrypted content that includes an encrypted tracing clip in correspondence with the content playback apparatus, the encrypted tracing clip having been generated by encrypting tracing clip data having tracing information embedded therein as a digital watermark.

Furthermore, the recording medium may further store thereon a predetermined number of encrypted tracing clip keys generated by encrypting, with use of the media key, each one of the predetermined number of mutually different tracing clip keys, wherein the encrypted content further includes the predetermined number of encrypted tracing clips in correspondence with the content playback apparatus, the encrypted tracing clips having been generated by encrypting each one of the predetermined number of tracing clips with a different one of tracing Clip keys, each one of the tracing clips having embedded therein as an electronic watermark, tracing information that is different from tracing information embedded in any other of the tracing clips.

Furthermore, the recording medium may further store thereon at least one encrypted general clip key that has been generated by encrypting at least one general clip key with use of the media key, wherein the encrypted content further includes a plurality of encrypted general clips in correspondence with the content playback apparatus, the plurality of encrypted general clips having been generated by encrypting each of a plurality of general clips with use of the at least one general clip key.

Furthermore, the recording medium may further store thereon playback order information showing an order of decrypting and playing the encrypted tracing clips and the encrypted general clips in correspondence with the content playback apparatus.

According to the stated structures, since a media key composed of a portion unique to the recording medium and a portion unique to the playback apparatus is generated, a recording medium can be generated that allows content to be decrypted only with a combination of a specific content playback apparatus and a specific recording medium.

Furthermore, the present invention is a content playback apparatus that decrypts and plays an encrypted content stored on the recording medium, the content playback apparatus including: a first decryption unit operable to decrypt, with use of a device key allocated to the content playback apparatus, an encrypted media key that is stored on the recording medium in correspondence with the content playback apparatus, thereby generating a decrypted media key; a second decryption unit operable to decrypt, with use of the generated decrypted media key, an encrypted tracing clip key stored on the recording medium, thereby generating a decrypted tracing clip key; a third decryption unit operable to decrypt, with use of the generated decrypted tracing clip key, an encrypted tracing clip that is stored on the recording medium in correspondence with the content playback apparatus, thereby generating a decrypted tracing clip; and a playback unit operable to play the generated decrypted tracing clip.

Furthermore, the present invention is the content playback apparatus, that decrypts and plays an encrypted content stored on the recording medium, wherein the second decryption unit further decrypts, with use of the generated decrypted media key, each of the predetermined number of encrypted tracing clip keys stored on the recording medium, thereby generating the predetermined number of decrypted tracing clip keys, the third decryption unit further decrypts, with use of each of the generated predetermined number of decrypted tracing clip keys, the predetermined number of encrypted tracing clips that are in correspondence with the playback apparatus, thereby generating the predetermined number of decrypted tracing clips, and the playback unit further plays the generated predetermined number of decrypted tracing clips.

Furthermore, the second decryption unit may further decrypt, with use of the generated decrypted media key, the at least one encrypted general clip key stored on the recording medium, thereby generating at least one decrypted general clip key, the third decryption unit may further decrypt, with use of the generated at least one decrypted general clip keys, the plurality of encrypted general clips stored on the recording medium of claim 8 and in correspondence with the content playback apparatus, thereby generating a plurality of decrypted general clips, and the playback unit may play the generated plurality of decrypted general clips.

Furthermore, the content playback apparatus may further include: a control unit operable to control the second decryption unit, the third decryption unit and the playback unit so as to decrypt and play the predetermined number of encrypted tracing clips and the plurality of encrypted general clips in accordance with the playback order information stored on the recording medium.

According to the stated structures, since a media key composed of a portion unique to the recording medium and a portion unique to the playback apparatus is generated, a recording medium can be generated that allows content to be decrypted only with a combination of a specific content playback apparatus and a specific recording medium.

### BRIEF DESCRIPTION OF THE DRAWINGS

FIG. 1 is a system structural diagram showing the structure of a content distribution system 10;

FIG. 2 is a block diagram showing the structure of a management server apparatus 200;

FIG. 3 is a data structure diagram showing the data structure of a device key information table group 211;

FIG. 4 is a data structure diagram showing the data structure of individual terminal decryption key information tables 214 and 214a;

FIG. 5 is a data structure diagram showing the data structure of a WM table 217;

FIG. 6 is a structural diagram showing the structure and playback order of content 280;

FIG. 7 is a structural diagram showing the structure of a tree structure 221 and a tree structure 231;

FIG. 8 is a flowchart showing operations by an output unit 205 for manufacturing a BD;

FIG. 9 is a flowchart showing operations by a re-formation unit 204 for re-forming, and is continued in FIG. 10;

FIG. 10 is a flowchart showing operations by a re-formation unit 204 for re-forming, and is continued in FIG. 11;

FIG. 11 is a flowchart showing operations by a re-formation unit 204 for re-forming, and is continued in FIG. 12;

FIG. 12 is a flowchart showing operations by a re-formation unit 204 for re-forming, and is continued in FIG. 13;

FIG. 13 is a flowchart showing operations by a re-formation unit 204 for re-forming, and is continued from FIG. 12;

FIG. 14 is a data structure diagram showing the data structure of a BD 600a;

FIG. 15 is a data structure diagram showing the data structure of a terminal-use playback information table 611;

FIG. 16 is a data structure diagram showing the data structure of playback control information 612a;

FIG. 17 is a data structure diagram showing the data structure of an individual terminal decryption key information table 613;

FIG. 18 is a data structure diagram showing the data structure of a medium unique information table 614;

FIG. 19 is a data structure diagram showing the data structure of a common decryption key information table 615;

FIG. 20 is a block diagram showing the structure of a playback apparatus 100a;

FIG. 21 is a data structure diagram showing the data structure of a device key information table 151;

FIG. 22 is a flowchart showing an outline of operations by the playback apparatus 100a;

FIG. 23 is a flowchart showing operations by a medium key generation unit 108 for generating a medium key;

FIG. 24 is a flowchart showing operations by a playback control information determination unit 110 for determining playback control information;

FIG. 25 is a flowchart showing operations for playing clip data;

FIG. 26 is a flowchart showing operations for generating an individual terminal decryption key;

FIG. 27 is a flowchart showing operations for decrypting and playing clip data;

FIG. 28 is a block diagram showing the structure of an inspection apparatus 400;

FIG. 29 shows an example of a WM data set 421;

FIG. 30 flowchart showing operations by an inspection apparatus 400;

FIG. 31 shows an example of a group structure 731 and a group structure 741;

FIG. 32 is a data structure diagram showing the data structure of a device key information group 800;

FIG. 33 is a data structure diagram showing the data structure of individual terminal decryption key information terminals 821 and 821a;

FIG. 34 is a flowchart showing operations by the re-formation unit 204 as a modification, and is continued in FIG. 35;

FIG. 35 is a flowchart showing operations by the re-formation unit 204 as a modification, and is continued in FIG. 36;

FIG. 36 is a flowchart showing operations by the re-formation unit 204 as a modification, and is continued in FIG. 37; and

FIG. 37 is a flowchart showing operations by the re-formation unit 204 as a modification, and is continued from FIG. 36.

### DESCRIPTION OF REFERENCE NUMERALS

10 Content distribution system
100a-100c Playback apparatus
200 Management server apparatus
400 Inspection apparatus
500 Recording apparatus
600a-600c BD
650a-650c BD

### BEST MODE FOR CARRYING OUT THE INVENTION

### 1. First Embodiment

The following describes a content distribution system 10 as one embodiment of the present invention.

1.1 Structure of Content Distribution System 10

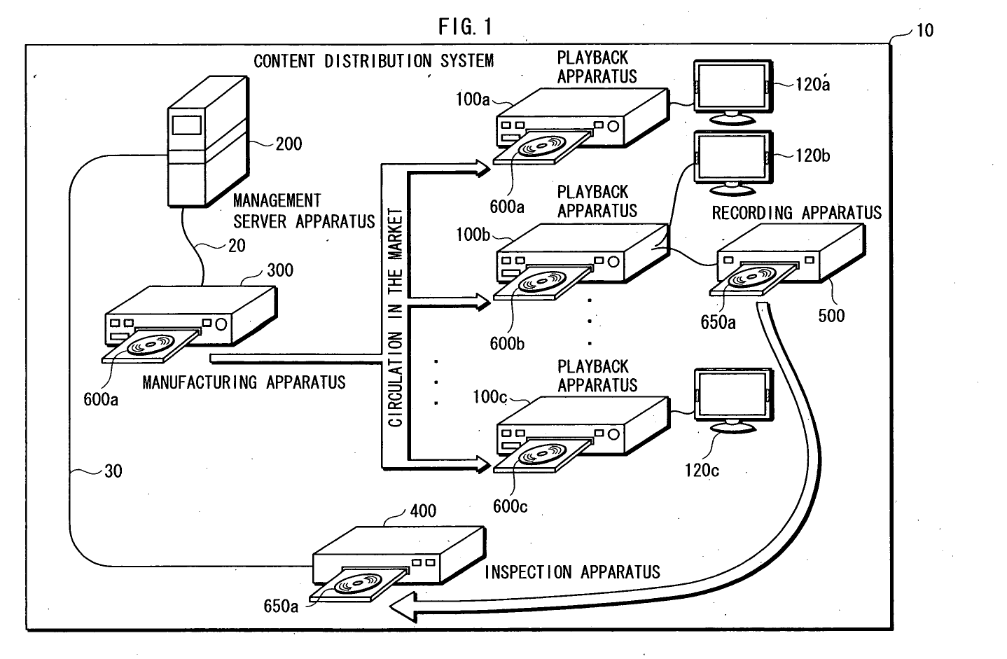

The content distribution system 10, as shown in FIG. 1, is composed of a management server apparatus 200, a manufacturing apparatus 300, playback apparatuses 100a, 100b, . . . 100c, a recording apparatus 500, and an inspection apparatus 400.

The management server apparatus 200 is connected to the manufacturing apparatus 300 by a dedicated line 20, and connected to the inspection apparatus 400 by a dedicated line 30. The management server apparatus 200, the manufacturing apparatus 300, and the inspection apparatus 400 are maintained and administered by a legitimate content copyright holder, or a manager thereof.

A monitor 120a is connected to the playback apparatus 100a, a monitor 120b and the recording apparatus 500 are connected to the playback apparatus 010b, and a monitor 120c is connected to the playback apparatus 100c.

The management server apparatus 200 manages the playback apparatuses 100a, 100b, . . . , 100c by dividing them into a plurality groups using a tree structure. The management server apparatus 200 encrypts content in which WM (watermark) information, in other words electronic watermark information, that specifies a group is embedded, and records the encrypted content and other information on BDs (Blu-ray Discs) 600a, 600b, . . . , 600c by way of the manufacturing apparatus 300. The BDs 600a, 600b, . . . , 600c are distributed by being put on the market with authorization.

When the BD 600a that has been purchased legitimately by a user is mounted in the playback apparatus 100a, the playback apparatus 100a decrypts and plays the encrypted content recorded on the BD 600a, and outputs the played content to the monitor 120a.

When the legitimately purchased BD 600b is mounted in the playback apparatus 100b by a different user, the playback apparatus 600b decrypts and plays the encrypted content recorded on the BD 600b, and outputs the played content to the monitor 120b and the recording apparatus 500. The recording apparatus 500 receives the played content, and records the received content on BDs 650a, 650b, . . . , 650c.

The BDs 650a, 650b, . . . , 650c are recording media produced by unauthorized copying. The BDs 650a, 650b, . . . , 650c are distributed without authorization in the market.

When the BD 650a that has been produced by unauthorized copying is discovered, the legitimate copyright holder of the content mounts the BD 650a in the inspection apparatus 400. The inspection apparatus 400 reads the content from the BD 650a, detects the WM information from the read content, and transmits the detected WM information to the management server apparatus 200 via the dedicated line 30.

Using the received WM information, the management server apparatus 200 specifies the group that includes the playback apparatus 100b associated with unauthorized usage, and divides the playback apparatuses belonging to the specified group into a plurality of groups such that each one playback apparatus belongs to a group of one playback apparatus. The management server apparatus 200 then integrates the groups, except the group of the group specified by the WM information, into one group. Next, the management server apparatus 200 embeds WM information unique to the new group in the content, and as described above, encrypts the content in which the WM information for specifying the new group has been embedded, and records the encrypted content and other information on a plurality of BDs by way of the manufacturing apparatus 300. These BDs are distributed by being sold legally in the market.

The encrypted content recorded on the BDs manufactured in this way is once again played back by the playback apparatus 100b, copied without authorization by the recording apparatus 500, and resultant unauthorized BDs are distributed without authorization in the market. Next, as described above, the inspection apparatus 400 plays the content from an unauthorized BD, and extracts the WM information from the played content. Since, as described above, the WM information specifies the group that includes only the playback apparatus 100b, the playback apparatus 100b used in an unauthorized manner can be uniquely specified.

Note that in the present embodiment and modifications thereof, AES (Advanced Encryption Standard) is the method used to encrypt data. However, the encryption method used is not limited to being AES, and another encryption method may be used.

1.2 Structure of the Management Server Apparatus 200

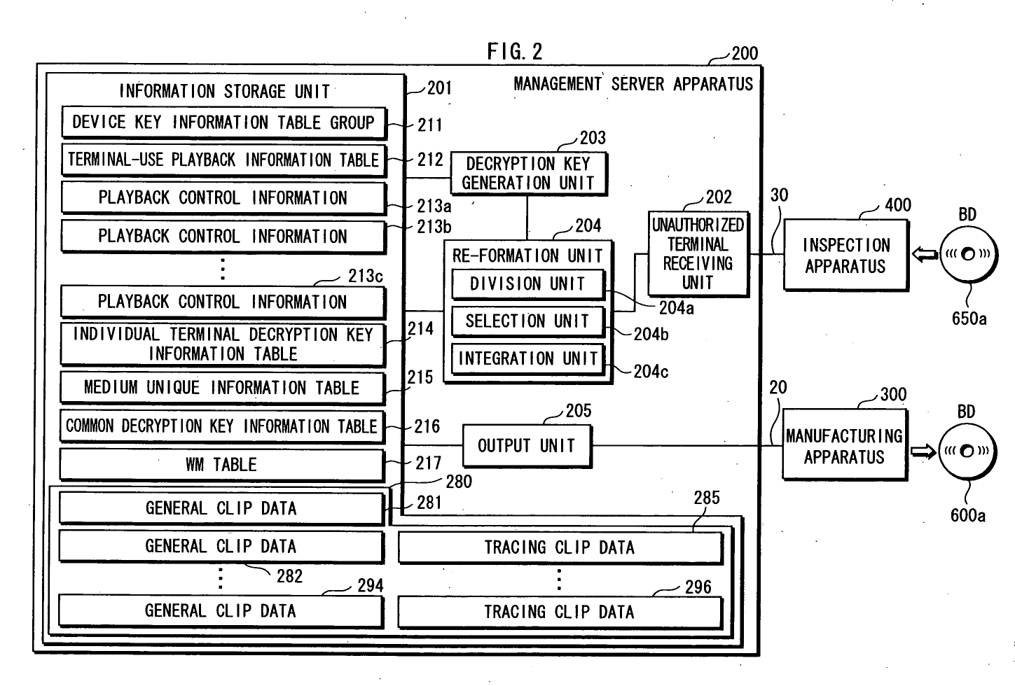

The management server apparatus 200, as shown in FIG. 2, is composed of an information storage unit 201, an unauthorized terminal receiving unit 202, a decryption key generation unit 203, a re-formation unit 204, and an output unit 205. The re-formation unit 204 is composed of a division unit 204a, a selection unit 204b, and an integration unit 204c.

The management server apparatus 200 is, specifically, a computer system composed of a microprocessor, a ROM, a RAM, a hard disk unit, a communication unit, a display unit, a keyboard, a mouse and the like. Computer programs are stored in the RAM or the hard disk unit, and the management server apparatus 200 achieves part of its functions by the microprocessor operating in accordance with the computer programs.

(1) Information Storage Unit 201

The information storage unit 201, as shown in FIG. 2, stores a device key information table group 211, a terminal-use playback information table 212, playback control information 213a, playback control information 213b, . . . , playback control information 213c, a individual terminal decryption key information table 214, a medium unique information table 215, a common decryption key information table 216, a WM table 217, and content 280.

(Device Key Information Table Group 211)

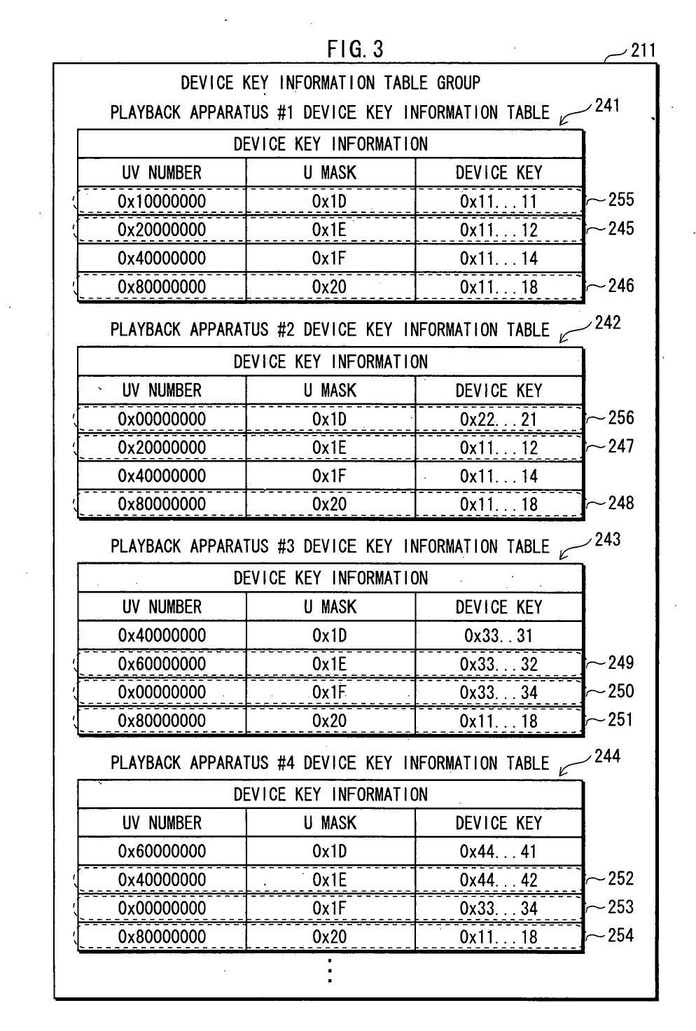

One example of the device key information table group 211 is shown in FIG. 3. The device key information table 211 is composed of device key information tables 241, 242, . . . , 243, . . . , 244, . . . equivalent in number to the playback apparatuses 100a, 100b, . . . , 100c in the content distribution system 10. The device key information tables 241, 242, . . . , 243, . . . , 244, . . . correspond respectively to the playback apparatuses 100a, 100b, . . . , 100c, and are each identified by identification information that uniquely identifies the corresponding one of the playback apparatuses 100a, 100b, . . . , 100c.

The device key information tables 241, 242, . . . , 243, . . . , 244, . . . are each distributed in the corresponding one of the playback apparatuses 100a, 100b, . . . , 100c.

The following gives a description of the device key information tables 241. Since the device key information tables 242, . . . , 243, . . . , 244, . . . have the same structure as the device key information table 241, a description of these is omitted.

The device key information table 241, as shown in FIG. 3, is composed of a plurality of pieces of device key information. Each piece of device key information corresponds to a node in a tree structure, and includes a UV number, a U mask, and a device key.

Note that the UV numbers and the U masks are defined in an NNL system. Details of NNL systems can be found in the following document.

D. Naor, M. Naor, and J. Lotspiech, “Revocation and tracing routines for stateless receivers” in Lecture Notes in Computer Science, Advances in Cryptology. Heidelberg, Germany: Springer-Verlag, 2001, vol. 2139

Each UV number 4 is four bytes in length, and each U mask is one byte in length. Each playback apparatus must use a content key specified by the UV number and a U mask to play content recorded on a BD.

For instance, a playback apparatus having a device key corresponding to a node in an NNL system specified by a UV number “0x10000000” and a U mask “0x1D” uses that device key when playing content.

The UV number and the U mask are information showing a node in a tree structure, with the U mask showing how many lower order bits of the UV number can be ignored. The UV number excluding the lower order bits shown by the U mask shows a node in the tree structure.

The tree structure is composed of a plurality of nodes arranged in a multilayer tree-shape. Terminal apparatuses are allocated respectively to leaves in the tree structure. Initially, the terminal apparatuses are arranged in to a plurality of groups, each one group being composed of a plurality of terminal apparatuses allocated to respective leaves in a subtree whose root is a node belonging to a specific layer.

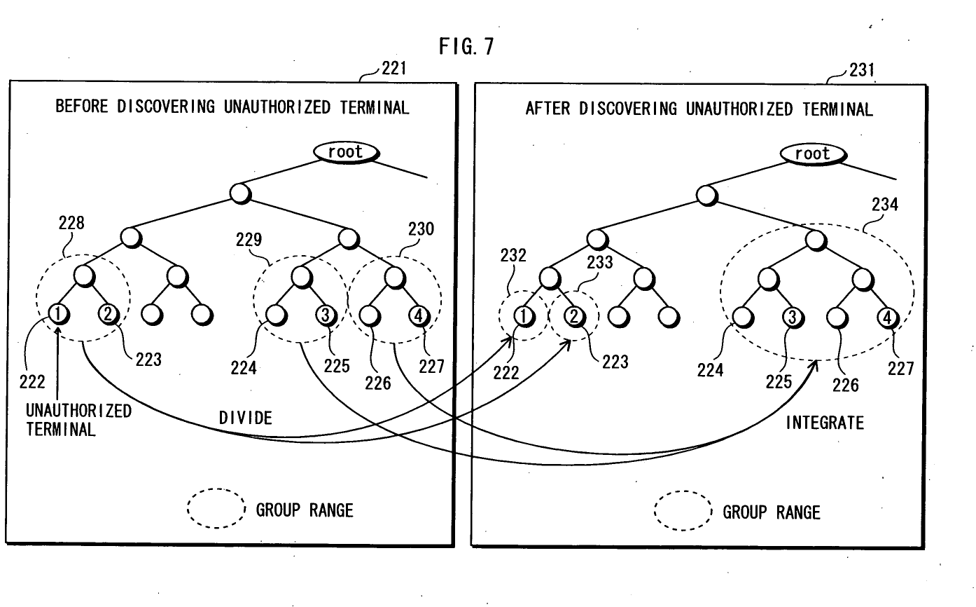

Here, an example of a tree structure is a tree structure 221 shown in FIG. 7. The tree structure 221 is a binary tree having five levels, and is composed of a plurality of nodes and a plurality of edges that connect the nodes.

The root of the tree structure has two directly subordinate nodes which are connected to the root via respective ones of two edges, and have respective node identification information “0” and “1”.

The node shown by the node identification information “0” has two directly subordinate nodes which are connected to the node via respective ones of two edges, and have respective node identification information “00” and “01”. The node shown by the node identification information “1” has two directly subordinate nodes that have respective node identification information “10” and “11”.

Further, the node shown by the node identification information “00” has two directly subordinate nodes that have respective node identification information “000” and “001”. The node shown by the node identification information “01” has two directly subordinate nodes that have respective node identification information “010” and “011”.

This is the same for the other nodes, and therefore a description is omitted.

As one example, when the UV number is “0x50000000” and the U mask is “0x1E”, the lowest “0x1E” bits of the UV number, in other words the lowest 30 bits (expressed in decimal), are masked, and therefore the remaining value in the UV number is “01” (expressed in binary). In other words, this UV number and U mask show the node having the node identification information “01”.

The device key is key information corresponding to the node shown by the UV number and the U mask included in the device key information.

Note that in FIG. 3, each character string following “0x” shows a hexadecimal expression. This is the same for the present specification and the other drawings.

(Terminal-Use Playback Information Table 212)

The terminal-use playback information table 212 is a table showing the correlation between playback apparatuses and playback control information. A detailed description is given below.

(Individual Terminal Decryption Key Information Table 214)

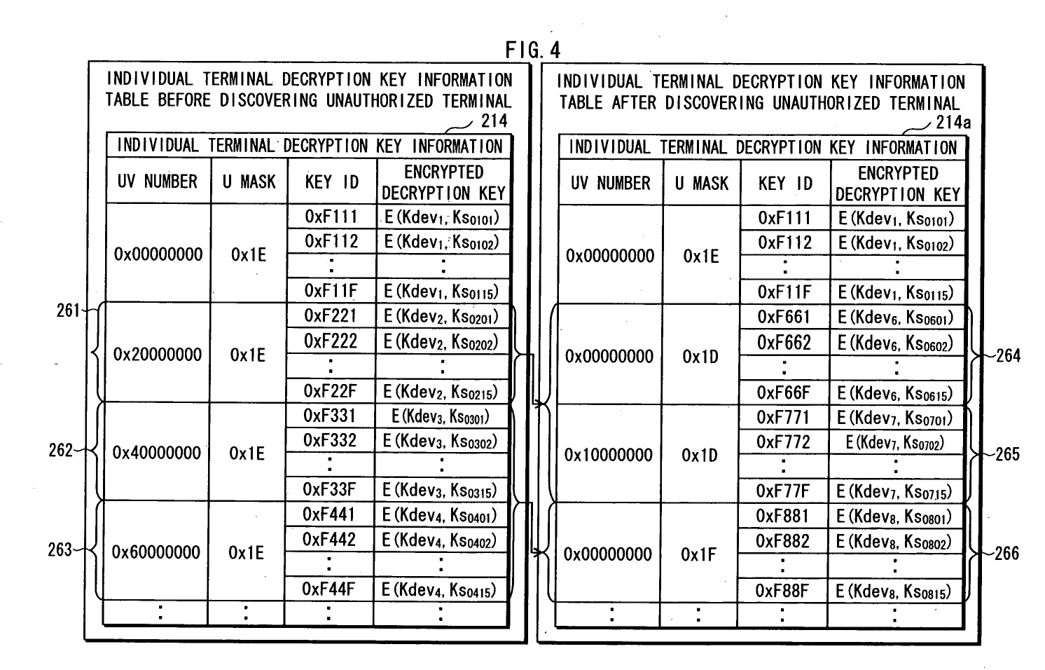

FIG. 4 shows one example of the individual terminal decryption key information table 214, which is composed of a plurality of pieces of individual terminal decryption key information. The pieces of individual terminal decryption key information correspond respectively to the nodes in the described tree structure.

Each piece of individual terminal decryption key information is composed of a UV number, a U mask, and 15 pieces of encrypted decryption key information.

The UV numbers and U masks are as described above.

Each piece of encrypted decryption key information is composed of a key ID and an encrypted decryption key. The encrypted decryption key has been generated by encrypting a decryption key with use of a device key. Here, the device key is a device key specified by the UV number and the U mask included in the piece of individual terminal decryption key information.

The 15 device keys used when generating the 15 encrypted decryption keys included respectively in the 15 pieces of encrypted decryption key information are identical. The 15 decryption keys used as a basis when generating the 15 encrypted decryption keys included respectively in the 15 pieces of encrypted decryption key information are respectively different.

Note that the individual terminal decryption key information table 214 shown in FIG. 4 is that before an unauthorized BD is discovered, and the individual terminal decryption key information table 214a shown in FIG. 4 is that after an unauthorized BD is discovered and is the result of the management server apparatus 200 re-forming the groups. The individual terminal decryption key information table 214a is described below.

(Medium Unique Information Table 215)

The medium unique information table 215 is a table showing the correlation between playback apparatuses and encrypted medium keys set for each medium. A detailed description is given below.

(Common Decryption Key Information Table 216)

The common decryption key information table 216 is a table that defines common decryption key used when playing encrypted content. A detailed description is given below.

(WM Table 217)

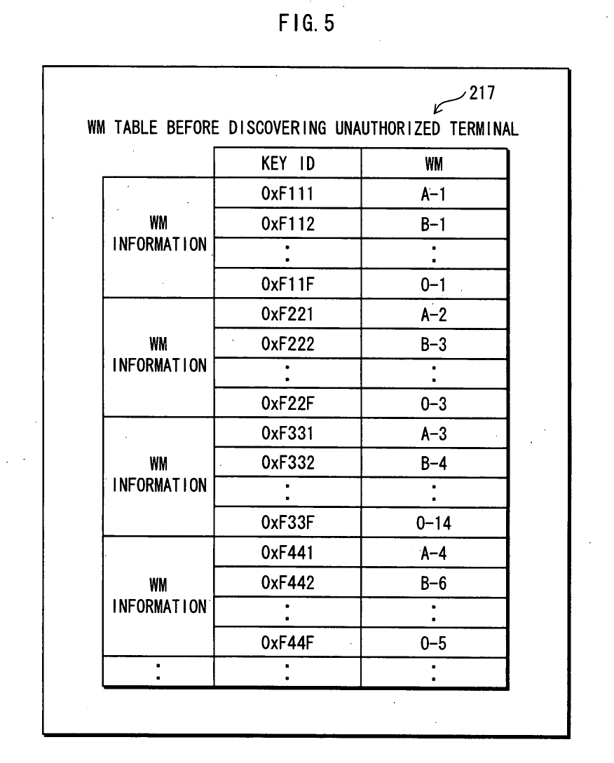

The WM table 217, as shown in FIG. 5, is composed of a plurality of pieces of WM information which correspond respectively to the pieces of individual terminal decryption key information included in the individual terminal decryption key information table 214 shown in FIG. 4. As shown in FIG. 5, each piece of WM information includes a group of 15 WMs.

Each WM group includes a key ID and a WM. The key ID is as described above. The WM is a watermark embedded in the content.

The 15 WM groups included in a piece of WM information in the WM table 217 correspond respectively to the 15 pieces of encrypted decryption key information in the individual terminal decryption key information in the individual terminal decryption key information table 214 corresponding to the piece of WM information. In other words, the 15 key IDs in the corresponding piece of WM information are identical to the 15 key IDs included in the individual terminal decryption key information in the individual terminal decryption key information table 214 corresponding to the piece of WM information.

Note that the 15 WMs in a piece of WM information are referred to as a WM set.

(Content 280)

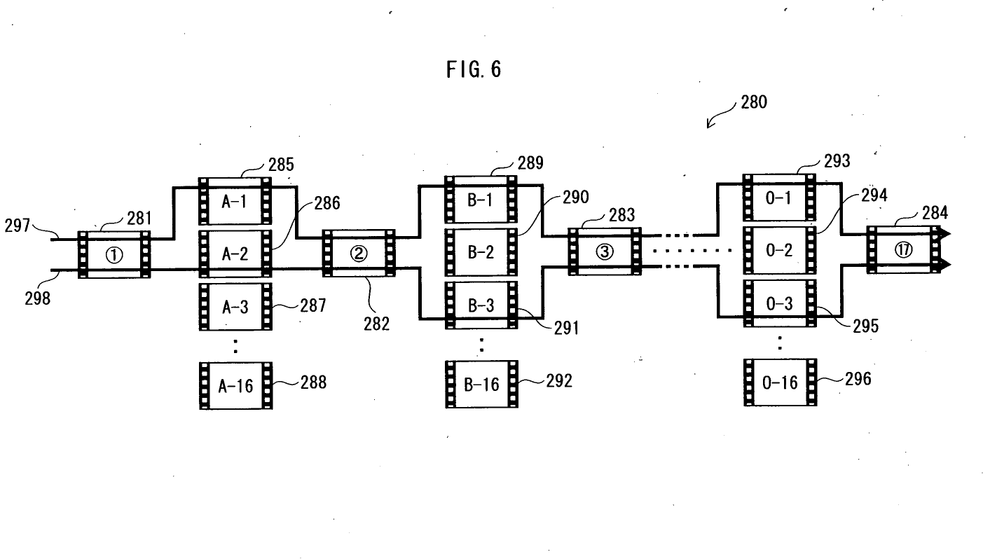

An example of the content 280 is shown in FIG. 6. In FIG. 6, the content 280 is composed of 17 pieces of general clip data 281, 282, 283, . . . , 284; 16 pieces of tracing clip data 285, 286, 287, . . . , 288 in a first segment; . . . ; and 16 pieces of tracing clip data 293, 294, 295, . . . in a fifteenth segment. In other words, the total number of pieces of tracing clip data in the content 280 is 240 (16 pieces×15 segments).

Each of the pieces of general clip data 281, 282, 283, 284 has been generated by compression encoding digital video information and digital audio information.

The 16 pieces of tracing clip data 285, 286, 287, . . . , 288 in the first segment have been generated by compression encoding identical digital video information and digital audio information. However, different WMs are embedded in advance in the analog audio signals used as a basis to generate the digital audio information. Specifically, a different one of the WMs “A-1”, “A-2”, “A-3”, . . . , “A-16” shown in FIG. 6 is embedded in each of analog audio signals corresponding respectively to the 16 pieces of tracing clip data 285, 286, 287, . . . , 288 in the first segment.

The 16 pieces of tracing clip data 289, 290, 291, . . . , 292 in the second segment have been generated by compression encoding identical digital video information and digital audio information. However, different WMs are embedded in advance in the analog audio signals used as a basis to generate the digital audio information. Specifically, a different one of the WMs “B-1”, “B-2”, “B-3”, . . . , “B-16” shown in FIG. 6 is embedded in each of analog audio signals corresponding respectively to the 16 pieces of tracing clip data 289, 290, 291, . . . , 292 in the second segment.

The tracing clip data in other segments is composed similarly.

The playback order of the general clip data and the tracing clip data is defined by the playback control information 213a, the playback control information 213b, . . . , the playback control information 213c.

(Playback control information 213a, playback control information 213b, . . . , playback control information 213c)

The playback control information 213a, the playback control information 213b, . . . , and the playback control information 213c define the playback order of the general clip data and the tracing clip data in the content. A description of this playback control information is given below.

(2) Output Unit 205

(Processing Before an Unauthorized Group is Discovered)

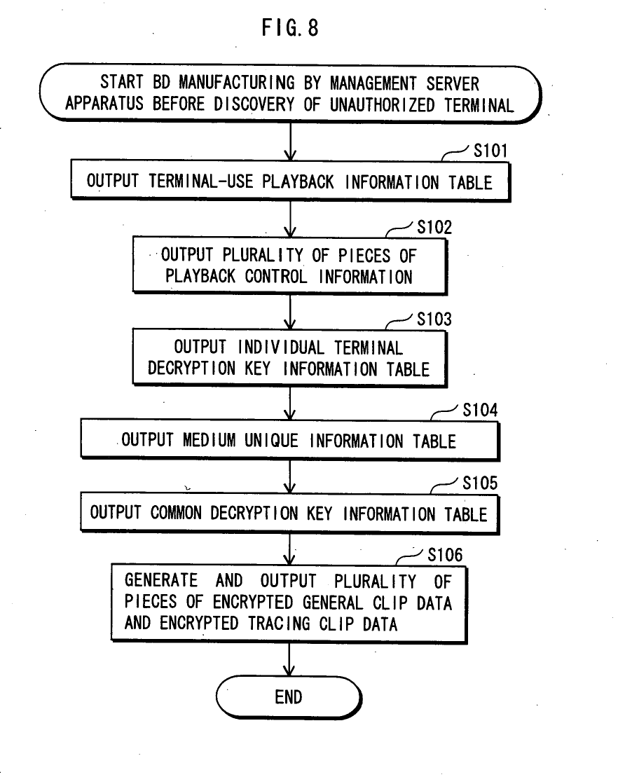

The output unit 205 is described with use of the flowchart shown in FIG. 8.

When an unauthorized group has not yet been discovered, the output unit 205 reads the terminal-use playback information table 212, the playback control information 213a, 213b, . . . , 213c, the individual terminal key information table 214, the medium unique information table 215, and the common key decryption information table 216 from the information storage unit 201, and, to the manufacturing apparatus 300, outputs the read terminal-use playback information table 212 (step S101), outputs the read playback control information 213a, 213b, . . . , 213c (step S102), outputs the read individual terminal key information table 214 (step S103), outputs the read medium unique information table 215 (step S104), and outputs the common decryption key information table 216 (step S105).

Furthermore, the output unit 205 reads the pieces of general clip data 281, 282, 283, . . . , 284, the pieces of tracing clip data 285, 286, 287, . . . , 288, the pieces of tracing clip data 289, 290, 291, . . . , 292, . . . , and the pieces of tracing clip data 293, 294, 295, . . . , 296 from the information storage unit 201, and using the corresponding encryption keys, encrypts the read general clip data and tracing clip data, to generate encrypted general clip data and encrypted tracing clip data. The output unit 205 then outputs the generated general clip data and tracing clip data to the manufacturing apparatus 300, and instructs the manufacturing apparatus 300 to record this information on the BD 600a (step S106).

(Processing after an Unauthorized Group is Discovered)

When an unauthorized group has been discovered, the output unit 205 updates the terminal-use playback information table and the medium unique information table 215 using a tree structure in which the terminal apparatus groups have been re-formed. When the groups have been re-formed, the individual terminal decryption key information table is updated.

Using this updated information, the output unit 205 outputs the information to the manufacturing apparatus 300 and instructs the manufacturing apparatus 300 to record this information to a BD, in the same was as before the unauthorized group was discovered.

(3) Unauthorized Terminal Receiving Unit 202

The unauthorized terminal receiving unit 202 receives the WM set from the inspection apparatus 400 via the dedicated line 30, and outputs the received WM set to the re-formation unit 204. As described above, the WM set is composed of 15 WMs. As one example, here the received WM set is {“A-2”, “B-3”, . . . , “O-3”}.

(4) Re-Formation Unit 204

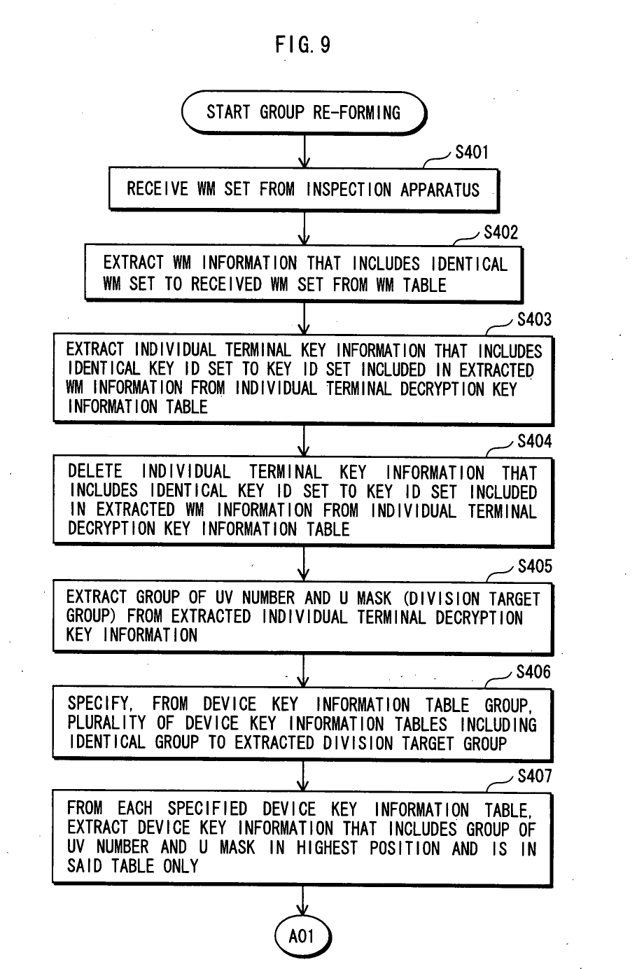

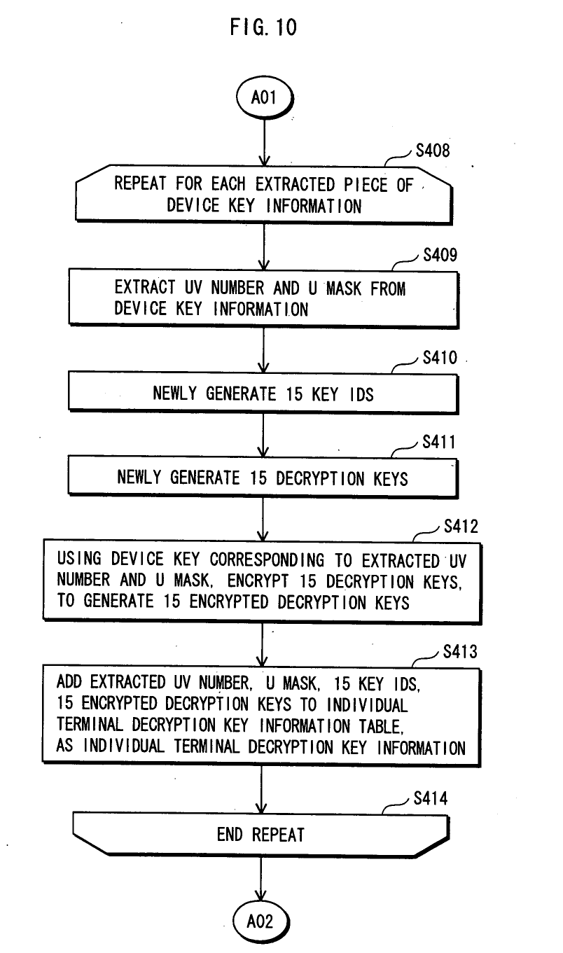

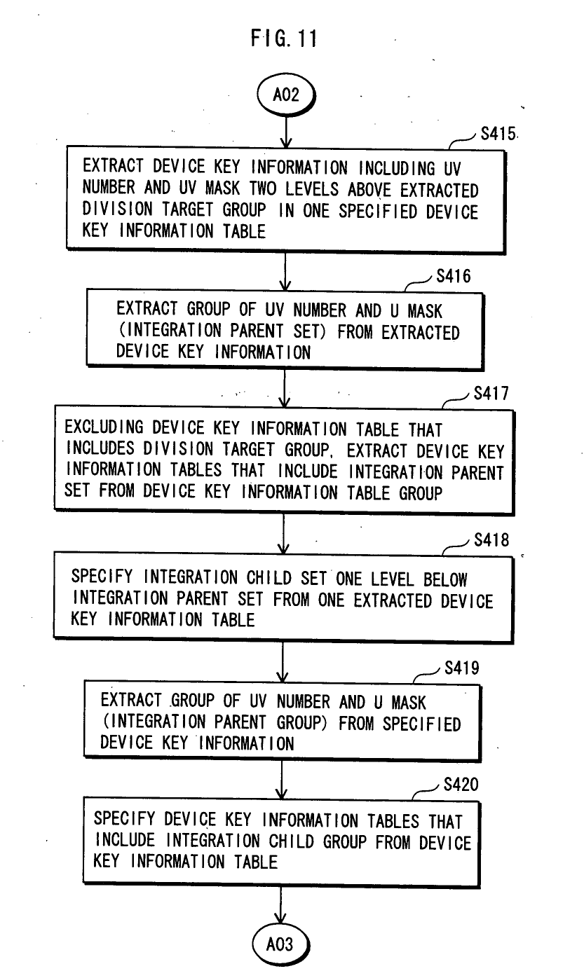

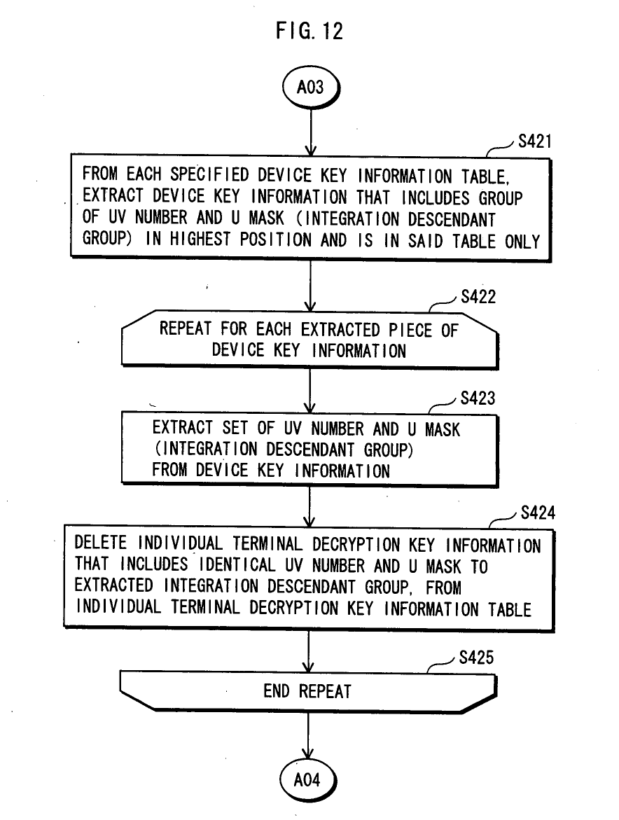

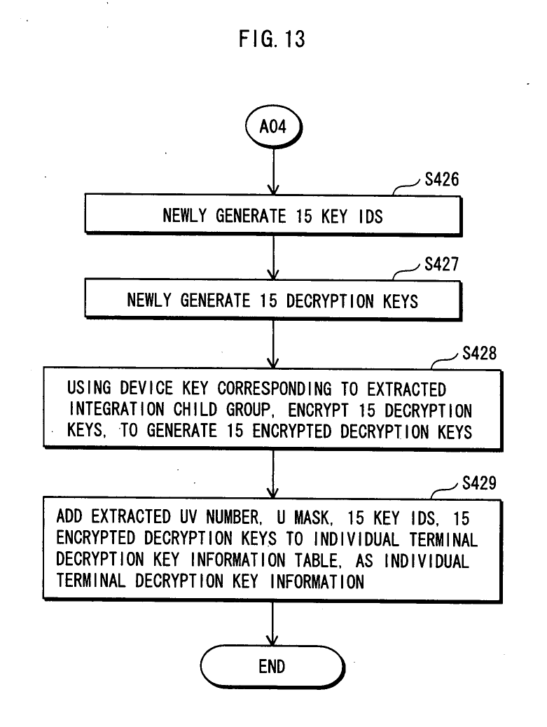

The re-formation unit 204 is described using the flowchart in FIG. 9 to FIG. 13, and giving a specific example.

The re-formation unit 204 receives a WM set from the unauthorized terminal receiving unit 202 (step S401). As one example, the received WM set is {“A-2”, “B-3”, . . . , “O-3”}.

(Group Division)

Upon receiving the WM set, the re-formation unit 204 extracts WM information that is identical to the received WM set from WM table 217 in the information storage unit 201 (step S402). As one example, in the WM table 217 shown in FIG. 5, the WM information that includes the WM set identical to the received WM set {“A-2”, “B-3”, . . . , “O-3”} is the WM set that includes the key ID set {“0xF221”, “0xF222”, . . . , “0xF22F”}.

Next, the re-formation unit 204 extracts the key ID set made up of 15 key IDs from the extracted WM information, and extracts individual terminal decryption key information that includes a key ID set identical to the extracted key ID set from the individual terminal decryption key information table 214 (step S403). As one example, the key ID set {“0xF221”, “0xF222”, . . . , “0xF22F”} is extracted from the extracted WM information, and the individual terminal decryption key information 261 that includes a key ID set identical to the extracted key ID set is extracted. As shown in FIG. 4, the individual terminal decryption key information 261 includes the set of key IDs {“0xF221”, “0xF222”, . . . , “0xF22F”}.

Next, the re-formation unit 204 deletes the individual terminal decryption key information that includes the key ID set identical to the extracted key ID set from the individual terminal decryption key information table 214 (step S404). As one example, the individual terminal decryption key information 261 is deleted.

Next, the re-formation unit 204 extracts a set of a UV number and a U mask (hereinafter, referred to as a division target set), from the extracted individual terminal key information (step S405). As one example, a division target set consisting of the UV number “0x20000000” and the U mask “0x1E” from the individual terminal decryption key information 261.

Next, the re-formation unit 204 specifies a plurality of device key information tables that include the same set as the extracted division target set, from the device key information table group 211 (step S406). As one example, the device key information tables that include the same set as the division target set consisting of the UV number “0x20000000” and the U mask “0x1E” are the device key information tables 241 and 242 shown in FIG. 3.

Next, the re-formation unit 204 extracts, from each of the specified device key information tables, device key information that is included only in the specified device key information table, and that includes a set of a UV number and a U mask corresponding to a highest node on a root side in the tree structure (step S407). As one example, the device key information that is extracted is the device key information 255 in the device key information table 241 and the device key information 256 in the device key information table 242.

Next, at step S408 to step S414, the re-formation unit 204 repeats step S409 to step S413 for each extracted piece of device key information. As one example, step S409 to step S413 is repeated for the device key information 255 and the device key information 256. The device key information 255 is used as an example in the following.

The re-formation unit 204 extracts the UV number and the U mask from the device key information (step S409). As one example, the UV number “0x10000000” and the U mask “0x1D” are extracted from the device key information 255.

The re-formation unit 204 newly generates 15 unique key IDs (step S410). An example of the 15 generated key IDs is the key IDs “0xF661”, “0xF662”, . . . , “0xF66F” included in the individual terminal decryption key information 264 in the individual terminal decryption key information table 214a shown in FIG. 4.

Next, the re-formation unit 204 generates 15 random numbers, and newly generates 15 decryption keys by making these random numbers the decryption keys (step S411). An example of the 15 generated decryption keys is the decryption keys Ks₀₆₀₁, Ks₀₆₀₂, . . . , Ks₀₆₁₅ shown in the individual terminal decryption key information 264 in the individual terminal decryption key table 214a shown in FIG. 4.

Next, the re-formation unit 204 encrypts the generated decryption keys using the device key corresponding to the extracted UV number and U mask, to generate 15 encrypted decryption keys (step S412). As one example, the device key corresponding to the UV number and the U mask is “0x11 . . . 11”. For brevity, this device key is expressed as Kdev₆ in the individual terminal decryption key table 214a shown in FIG. 4. The generated 15 encrypted decryption keys are E(Kdev₆, Ks₀₆₀₁), E (Kdev₆, Ks₀₆₀₂), . . . , E(Kdev₆, Ks₀₆₁₅).

Here, E(A, B) expresses a cipher text obtained by subjecting a plaintext B to an encryption algorithm E. As one example, the encryption algorithm E conforms to AES.

Next, the re-formation unit 204 writes the extracted UV number and U mask, the 15 generated key IDs and the 15 generated encrypted decryption keys to the individual terminal decryption key information table 214 as individual terminal decryption key information. At this time, the re-formation unit 204 associates the 15 key IDs with the encrypted decryption keys (step S413). As one example, the individual terminal decryption key information 264 is written to the individual terminal decryption key information table 214a shown in FIG. 4.

As one example, step S409 to step S413 are also performed with respect to the device key information 256, and the individual terminal decryption key information 265 is written in the individual terminal information table 214a shown in FIG. 4.

According to the described processing, as one example, the individual terminal decryption key information 264 and 265 are recorded in the individual terminal decryption key information table 214a shown in FIG. 4 instead of the individual terminal decryption key information 261 in the individual terminal decryption key information table 214 shown in FIG. 4.

As one example, the UV number “0x20000000” and the U mask “0xE1” in the individual terminal decryption key information 261 are in the device key information tables 241 and 242. However, after the group division, the UV number “0x00000000” and the U mask “0x1D” included in the individual terminal decryption key information 264 are included only in the device key information table 242, and the UV number “0x10000000” and the U mask “0x1D” included in the individual terminal decryption key information 265 are included only in the device key information table 241.

In this way, as shown in FIG. 7, the playback apparatuses 222 and 223 that belonged to a same group 228 in the tree structure 221 end up belonging to different groups (namely, groups 232 and 233) in the tree structure 231 as a result of the group division.

Note that the operations at steps S402 to S414 are performed by the division unit 204a in the re-formation unit 204.

As has been described, the division unit 204a selects a node subordinate to the target node corresponding to the group to which the terminal apparatus relating to the unauthorized usage belongs, and for each subtree whose root is a selected subordinate node, newly generates one group to which the one or more playback apparatuses allocated to the one or more leaves in the subtree belong.

(Group Integration)

The re-formation unit 204 extracts device key information that includes a UV number and a U mask two levels above the extracted division target set in the tree structure, from one of the device key information tables specified at step S406 (step S415). As one example, the device key information tables specified at step S406 are the device key information tables 241 and 242 shown in FIG. 3. Here, it is assumed that the device key information table 241 is selected from among the device key information tables 241 and 242. In the device key information table 241, the extracted division target group is the UV number “0x20000000” and the U mask “0xE1”, and the UV number and the U mask two levels above the division target group is the UV number “0x80000000” and the U mask “0x20”. Therefore, the device key information 246 that includes the UV number “0x80000000” and the U mask “0x20” is extracted from the device key information table 241.

Next, the re-formation unit 204 extracts the UV number and the U mask (integration parent set) from the extracted device key information (step S416). As one example, the UV number “0x80000000” and the U mask “0x20” are extracted from the device key information 246 as the integration parent set.

Next, the re-formation unit 204 extracts a plurality of device key information tables (excluding the device key information table that includes the division target group) that include the integration parent set from device key information group 211 (step S417). As one example, the device key information tables that include the division target group are the device key information tables 241 and 242. Therefore, the device key information tables 243, . . . , 244 that include the UV number “0x80000000” and the U mask “0x20” that are the integration parent group are extracted from among the device key information tables excluding the device key information tables 241 and 242.

Next, the re-formation unit 204 specifies device key information that includes an integration child set that is one level below the integration parent set, from one of the extracted device key information tables (step S418). As one example, the device key information table 243 is selected from among the extracted device key information tables 243, . . . , 244. The device key information 250 includes the UV number “0x00000000” and the U mask “0x1F” that are the integration child set one level below the “0x80000000” and the U mask “0x20” that are the integration parent set is specified from the selected device key information table 243.

Next, the re-formation unit 204 extracts the set of the UV number and U mask (integration child set) from the specified device key information (step S419). As one example, the UV number “0x00000000” and the U mask “0x1F” are extracted from the device key information 250.

Next, the re-formation unit 204 specifies a plurality of device key information tables that include the integration child set extracted from the device key information table group 211 (step S420). Here, since the extracted integration child set is the UV number “0x00000000” and the U mask “0x1F”, the device key information table 243 and 244 that include the UV number “0x00000000” and the U mask “0x1F” are extracted.

Next, the re-formation unit 204 extracts, for each of the device key information tables specified at step S420, device key information that is included only in the specified device key information table, and that includes a group of a UV number and a U mask (integration descendant group) corresponding to a highest node on a root side in the tree structure (step S421). As one example, the device key information that is extracted is the device key information 249 in the device key information table 243 and the device key information 252 in the device key information table 244.

Next, at step S422 to step S425, the re-formation unit 204 repeats step S423 to step S424 for each extracted piece of device key information. As one example, step S423 to step S424 is repeated for the device key information 249 and the device key information 252. The device key information 249 is used as an example in the following.

The re-formation unit 204 extracts the UV number and the U mask (integration descendant set) from the device key information (step S423). As one example, the UV number “0x60000000” and the U mask “0x1E” are extracted from the device key information 249. Next, the re-formation unit 204 deletes the individual terminal decryption key information that includes the UV number and the U mask identical to the extracted integration descendant group from the individual terminal decryption key information table 214 (step S424). As one example, since the integration descendant group is the UV number “0x60000000” and the U mask “0x1E”, the individual terminal decryption key information 263 is deleted from the individual terminal decryption key information table 214.

As one example, the step S423 to step S424 are also performed with respect to the device key information 252, and the individual terminal decryption key information 262 is deleted from the individual terminal decryption key information table 214 shown in FIG. 4.

Next, the re-formation unit 204 newly generates 15 unique key IDs (step S426). As one example, the 15 generated key IDs are the key IDs “0xF881”, “0xF882”, . . . , “0xF88F” included in the individual terminal decryption key information 266 in the individual terminal decryption key information table 214a shown in FIG. 4.

Next, the re-formation unit 204 generates 15 random numbers, and newly generates 15 decryption keys by making these random numbers the decryption keys (step S427). An example of the 15 generated decryption keys is the decryption keys Ks₀₈₀₁, Ks₀₈₀₂, . . . , Ks₀₈₁₅ shown in the individual terminal decryption key information 266 in the individual terminal decryption key table 214a shown in FIG. 4.

Next, the re-formation unit 204 encrypts the generated decryption keys using the device key corresponding to the extracted UV number and U mask, to generate 15 encrypted decryption keys (step S428). As one example, the device key corresponding to the UV number “0x00000000” and the U mask “0x1F” that are the integration child set is “0x33 . . . 34”. For brevity, this device key is expressed as Kdev₈ in the individual terminal decryption key table 214a shown in FIG. 4. The generated 15 encrypted decryption keys are E(Kdev₈, Ks₀₈₀₁), E(Kdev₈, Ks₀₈₀₂), . . . , E(Kdev₈, Ks₀₈₁₅).

Next, the re-formation unit 204 writes the extracted UV number and U mask, the 15 generated key IDs and the 15 generated encrypted decryption keys to the individual terminal decryption key information table 214 as individual terminal decryption key information. At this time, the re-formation unit 204 associates the 15 key IDs with the encrypted decryption keys (step S429). As one example, the individual terminal decryption key information 266 is written to the individual terminal decryption key information table 214a shown in FIG. 4.

According to the described processing, the individual terminal decryption key information 266 is recorded in the individual terminal decryption key information table 214a shown in FIG. 4, instead of the individual terminal decryption key information 262 and 263 in the individual terminal decryption key information table 214 shown in FIG. 4.

Furthermore, as one example, the UV number “0x40000000” and the U mask “0xE1” in the individual terminal decryption key information 262 are in the device key information table 244 only, and the UV number “0x60000000” and the U mask “0x1E” in the individual terminal decryption key information 263 are in the device key information table 243 only. However, after the group division, the UV number “0x00000000” and the U mask “0x1F” included in the individual terminal decryption key information 266 are included in the device key information table 243 and 244.

In this way, as shown in FIG. 7, the playback apparatuses 225 and 227 that belonged to respectively different groups 229 and 230 in the tree structure 221, end up belonging to the same group 234 in the tree structure 231 as a result of the group integration.

Note that the operations at steps S415 to S420 are performed by the selection unit 204b in the re-formation unit 204, and the operations at steps S421 to S429 are performed by the integration unit 204c in the re-formation unit 204.

As has been described, the selection unit 204b selects a plurality of nodes that are subordinate to a superordinate node of the target node excluding the target node corresponding to the group to which the playback apparatus associated with unauthorized usage belongs, and selects groups corresponding to the selected subordinate nodes. The integration unit 204c integrates the selected groups into one group.

1.3 Manufacturing Apparatus

The manufacturing apparatus 300 receives the terminal-use playback information table 212, the playback control information 213a, 213b, . . . , 213c, the individual terminal decryption key information table 214, the medium unique information table 215, the common decryption key information table 216, and a plurality of pieces of clip data, from the management server apparatus 200 via the dedicated line 20, and records the received terminal-use playback information table, playback control information, individual terminal decryption key information table, medium unique information table, common decryption key information table, and encrypted clip data on the BDs 600a, 600b, . . . , 600c.

1.4 BDs 600a, 600b, . . . , 600c

Here, a description is given of the structure of the data on the BD 600a. Note that since the BDs 600b, . . . , 600c are the same as the BD 600a, a description thereof is omitted.

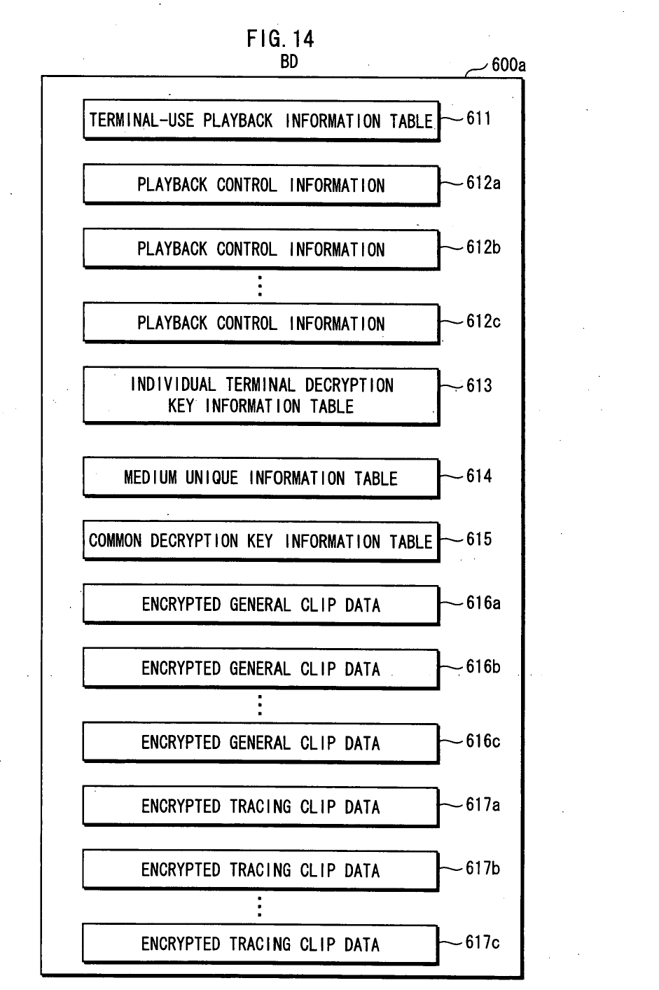

BD 600a is a BD medium that is a large capacity phase-change optical disc that is portable and re-writable, and is computer-readable. The BD 600a, as shown in FIG. 14, stores thereon a terminal-use playback information table 611, playback control information 612a, 612b, . . . , 612c, a individual terminal decryption key information table 613, a medium unique information table 614, a common decryption key information table 615, encrypted general clip data 616a, 616b, . . . , 616c, and encrypted tracing clip data 617a, 617b, . . . , 617c.

The BD medium has a file systems such as UDF (universal disk format), and therefore the information shown in FIG. 14 is stored in one or a plurality of files in the file system. However, the BD medium is not limited to this, and the medium unique information 614 may, for instance, use a method of recording to a special area of a lead-in area of the BD media, a method of recording with use of a BCA (burst cutting area), or a method of recoding information by creating intentional errors in error detection code.

(1) Terminal-Use Playback Information Table 611

Each playback apparatus stores a plurality of device keys (each device key being 128 bits). The terminal-use playback information table 611 is composed of information for designating a device key to be used when the playback apparatus plays content, and for specifying playback control information that defines clip data to actually decrypt and a playback order of the clip data.

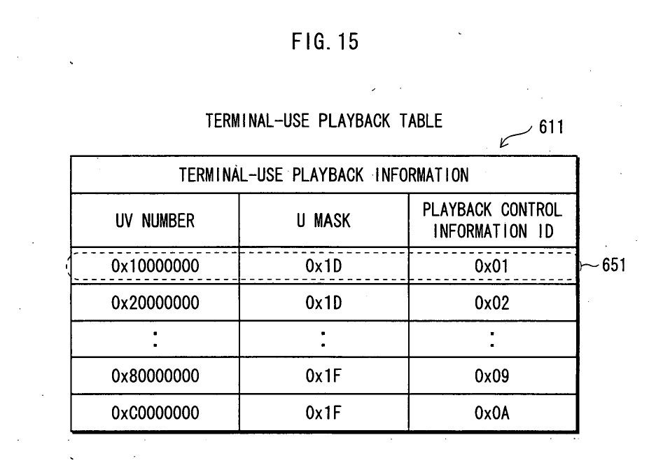

Specifically, as shown in FIG. 15, the terminal-use playback information table 611 is composed of a plurality of pieces of terminal-use playback information which correspond to the plurality of groups managed by the management server apparatus 200 as described above. The playback apparatuses 100a, 100b, . . . , 100c each belong to one of the groups. Each piece of terminal-use playback information is composed of a UV number, a U mask, and a playback control information ID.

As described above, each UV number is four bytes in length, and each U mask is one byte in length. Each playback apparatus must use a content key specified by a UV number and a U mask to play content recorded on a BD.

For instance, a playback apparatus having a device key corresponding to a node in an NNL system specified by a UV number “0x10000000” and a U mask “0x1D” uses that device key when playing content. Note that it is possible for a plurality of playback apparatuses to share a device key specified from a UV number, a U mask and a V mask calculated from the UV number. In this case, the playback devices sharing the same device key use identical terminal-use playback information.

Here, a description is given of the method used to calculate the V mask from the UV number. The V mask is determined according to the lowest bit that is “1” in the UV number. Expressed in code using C language, the calculation method is as follows:

long v#mask=0xFFFFFFFF;

while ((uv & ˜ v#mask)==0)v#mask<<=1;

The method used to specify the device key using the UV number, the U mask, and the V mask calculated from the UV number is described below.

The playback control information ID is an identifier that unique identifies the playback control information.

For instance, as shown in FIG. 15, the terminal-use playback information 651 shows that a playback apparatus having a device key corresponding to a node in an NNL system specified by a UV number “0x10000000” and a U mask “0x1D” plays content in accordance with playback control information 612a specified by the playback control information ID “0x01”.

(2) Playback Control Information 612a, 612b, . . . , 612c

Here, a description is given of the playback control information 612a. Note that the playback control information 612b, . . . , 612c has the same data structure as the playback control information 612a, and therefore a description thereof is omitted.

The playback control information 612a corresponds to one group as described above, and designates encrypted general clip data and encrypted tracing clip data to be decrypted and played by a playback apparatus belonging to the group, and defines the order of playback of the encrypted general clip data and encrypted tracing clip data.

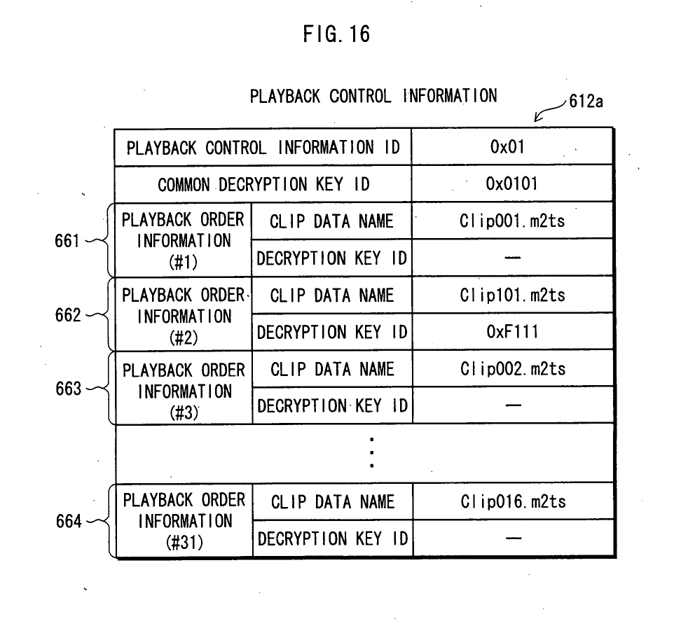

The playback control information 612a, as shown in FIG. 16, is composed of one playback control information ID, one common decryption key ID, and a plurality of pieces of playback order information.

The playback control information ID is identification information that uniquely identifies the piece of playback control information that includes the playback control ID.

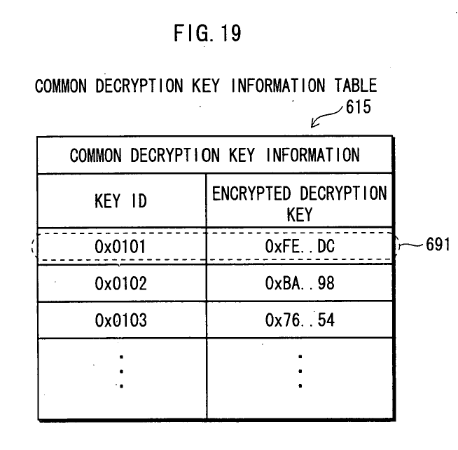

The common decryption key ID is identification information that identifies a decryption key used commonly for decryption of designated encrypted general clip data. The common decryption key ID shows a decryption key stored in the common key decryption key information table 615 shown in FIG. 19.

The plurality of pieces of playback order information are disposed in a predetermined order in the playback control information 612a. This order shows the order of playback of the pieces of clip data designated by the playback order information.

Each piece of playback order information includes a clip data name and a decryption key ID in association with each other.

Each clip data name is identification information that uniquely shows a encrypted general clip data or encrypted tracing clip data.

The decryption key ID is information designating a decryption key used when decrypting encrypted general clip data or encrypted tracing clip data shown by the clip name in association with the decryption key ID. When the decryption key ID is a dash (“-”), in other words when specific designation information is not shown, this means that a decryption key stored in the common decryption key information table 615 and shown by the common decryption key ID is used. On the other hand, when specific designation information is shown, for instance, when the decryption key ID is “0xF111”, the designation information shows a decryption key stored in the individual terminal decryption key information table 613 and shown by the key ID is used.

In this way, a playback order in which a playback apparatus plays clip data, and information for specifying decryption keys for clip data are described in the playback control information 612a, and the playback control information 612a is composed of a playback control information ID, a common decryption key ID for specifying a common decryption key used for decrypting clip data when a decryption key is not designated, and playback order information for clip data. The playback order information for clip data is composed of a clip data name and a decryption key ID for specifying decryption keys for clip data. Note that a plurality of pieces of playback control information are stored on each one BD.

The playback control information 612a shown in FIG. 16 is specified by the playback control information ID “0x01”, and the content played in accordance with the playback control information 612a is composed of 31 pieces of clip data. A playback apparatus for which the playback control information ID “0x01” is specified must play the 31 pieces of clip data in accordance with the playback control information 612a in the following order: Clip001.m2ts, Clip101.m2ts, Clip002.m2ts, . . . , Clip016.m2ts.

Furthermore, a decryption key ID for specifying a decryption key for clip data is described in the playback order information. For instance, the playback control information 662 shows that a decryption key specified by the decryption key ID “0xF111” is used to decryption clip data “Clip101.m2ts”. Note that when the decryption key ID is “-” (not designated), this shows that the decryption key specified by the common decryption key ID “0x0101” described in the playback control information 612a.

Note that although in the present embodiment one piece of playback control information 612a is designated for all encrypted clipdata that composes the content, this may be divided into a plurality of pieces of playback control information. In such a case, it is suitable to include playback order information that the piece of playback control information is continued in another piece of playback control information in each piece of playback control information instead of including a clip data name. Here, the playback control information ID of the following piece of playback control information may be directly designated. Alternatively, the playback control information ID of the following piece of playback control information may be determined by referring to a value in a playback control information determination unit 110 in the terminal apparatus. This enables the playback control information ID of the following piece of playback control information to be different for each playback apparatus.

(3) Individual Terminal Decryption Key Information Table 613

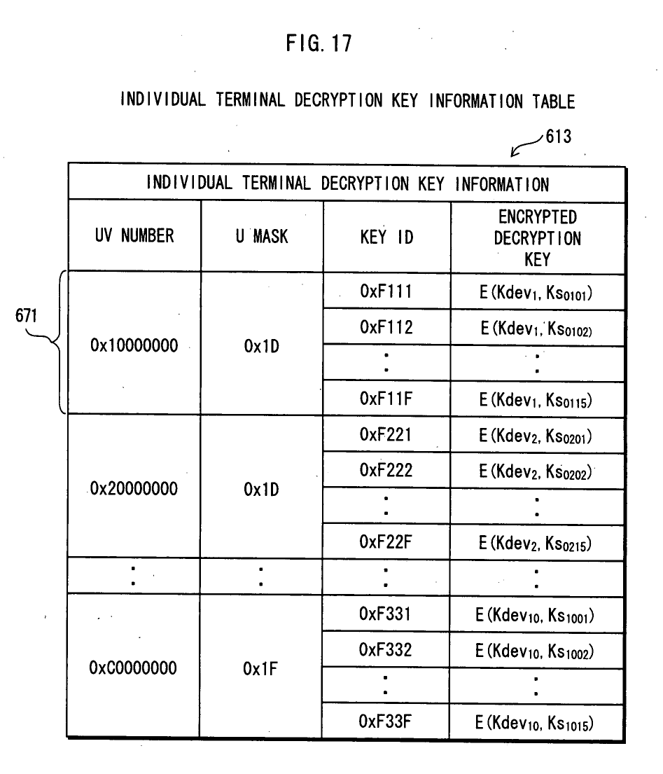

The individual terminal decryption key information table 613, as shown in FIG. 17, is composed of a plurality of pieces of individual terminal decryption key information. The plurality of pieces of individual terminal decryption key information correspond to the plurality of groups managed by the management server apparatus 200.

Each piece of individual terminal decryption key information is composed of a UV number, a U mask, and 15 key information sets. Each key information set is composed of a key ID and an encrypted decryption key.

The UV number and U mask are as described above.

Each key ID is identification information that uniquely identifies the key information set in which the key ID is included.

Each encrypted decryption key has been generated by subjecting a decryption key to encryption with use of a device key allocated to the group corresponding to the piece of individual terminal decryption key information that includes the encrypted decryption key.

The 15 decryption keys used as a basis when generating the encrypted decryption keys in the 15 key information sets are respectively different.

In this way, the individual terminal decryption key information table 613 stores data obtained by encrypting decryption keys that differ for each playback apparatus. For instance, in FIG. 17, the individual terminal decryption key information 671 means that when a playback apparatus plays content using a device key specified by the UV number “0x10000000” and the U mask “0x1D”, a decryption key identified by key IDs “0xF111” to “0xF11F” is necessary. The individual terminal decryption key information 671 also means that the encrypted decryption key E(Kdev1, Ks0101) identified by the key ID “0xF111” is data that has been generated by encrypting a decryption key with use of a device key Kdev1 specified by the UV number “0x10000000” and a U mask “0x1D”.

Consequently, in order to obtain the decryption key identified by the key ID “0xF111”, the encrypted decryption key E (Kdev1, Ks0101) should be decrypted with the device key identified by the UV number “0x10000000” and the U mask “0x1D”.

Similarly, the encrypted decryption keys identified by key IDs “0xF112” to “0xF11F”, respectively, are decryption keys that have been encrypted with the device key specified by the UV number “0x10000000” and the U mask “0x1D”.

Note that the UV number and the U mask may be omitted. In this case, decryption keys are obtained by decrypting the encrypted decryption keys which are decrypted with a playback-use device key described later.

(4) Medium Unique Information Table 614

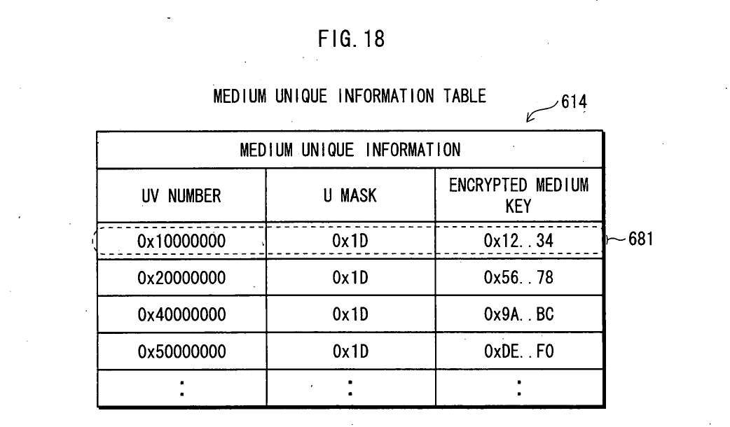

The medium unique information table 614, as shown in FIG. 18, is composed of a plurality of pieces of medium unique information.

The pieces of medium unique information correspond respectively to the plurality of groups managed by the management server apparatus 200 as described above.

Each piece of medium unique information is composed of a UV number, a U mask, an encrypted medium key.

The UV number and the U mask are as described above.

Each encrypted medium key has been generated by subjecting a medium key to encryption with use of a device key allocated to the group corresponding to the piece of medium unique information that includes the encrypted medium key.

The medium key is composed of information unique to the BD 600a stored in the medium unique information table 614, and information unique to the group corresponding to the medium unique information. When the length of the medium key is, for instance, 128 bits, the upper 64 bits are the information unique to the BD 600a, and the lower 64 bits are the information unique to the group corresponding to the medium unique information.

In this way, the medium unique information table 614 has written therein encrypted medium keys (128 bits) obtained by encrypting a medium key (128 bits) with use of, from among device keys held by the playback apparatus, the device keys held by only the playback device. This means that when a specific playback apparatus becomes an unauthorized device due to hacking or another reason, playback by this unauthorized device can be prevented by not recording the UV number, U mask and corresponding encrypted medium key of the device key held by the unauthorized playback apparatus to BDs. In FIG. 18, the medium unique information 681 shows that the medium key encrypted with the device key specified by the UV number “0x10000000” and the U mask “0xD1” is “0x12.34”.

(5) Common Decryption Key Information Table 615

The common decryption key information table 615, as shown in FIG. 19, is composed of a plurality of pieces of common decryption key information. The pieces of common decryption key information correspond respectively to the playback control information 612a, 612b, . . . , 612c.

Each piece of common decryption key information is composed of a key ID and an encrypted decryption key.

The key ID is identification information that uniquely identifies the common decryption key information that includes the key ID.

The encrypted decryption key has been obtained by encrypting, with use of the described medium key, a decryption key used in decryption of encrypted general clip data.

In this way, the common decryption key information table 615 has recorded therein information obtained by encrypting decryption keys for general clip data common to all playback apparatuses, with the medium key. The common decryption key information 691 shown in FIG. 19 shows that data obtained by encrypting a common decryption key specified by a key ID “0x1010” (2 bytes) with the medium unique key is “0xFE . . . DC” (128 bits). In order to obtain the common decryption key, the playback apparatus 100a should decrypt an encrypted decryption key with the medium unique key.

Note that although in the present embodiment the decryption key for general clip data common to all playback apparatuses is encrypted with medium keys to generate encrypted decryption keys, the decryption key for general clip data common to all playback apparatuses may instead be encrypted using a value obtained by subjecting unique ID information recorded on each BD and medium key to an exclusive OR operation XOR.

(6) Encrypted General Clip Data 616a, 616b, . . . , 616c, Encrypted Tracing Clip Data 617a, 617b, . . . , 617c

As described above, each encrypted clip data 616a, 616b, . . . , 616c has been generated by encrypting general clip data, and each encrypted tracing clip data 617a, 617b, . . . , 617c ahs been generated by encrypting tracing clip data.

Each piece of encrypted clip data is data obtained by encrypting a transport stream that is an MPEG 2 video elementary stream and an MPEG 2 audio elementary stream multiplexed using a method defined by MPEG 2. The encryption is performed by encrypting the payload of each packet of the transport stream excluding the adaptation field.

The encrypted clip data includes both data encrypted with a medium key and data encrypted with a device key. In the present embodiment, the content is composed of 16 pieces of encrypted clip data encrypted respectively with each of 16 medium keys, and 15 pieces of encrypted tracing data encrypted respectively with 15 device keys.

The encrypted tracing clip data encrypted with the device keys has unique information embedded therein as a watermark. For this reason, when content is distributed in an unauthorized manner, if the watermarks embedded in the pieces of clip data that make up distributed content are detected, the playback apparatus that decrypted the encrypted tracing clip data can be specified based on the combination of the watermarks.

Note that when a device key is used commonly be a plurality of playback apparatuses, instead of being able to specify one playback apparatus based on content distributed without authorization, only the group to which a plurality of playback apparatuses that share the device key used for playback of the content distributed without authorization can be specified.

In this case, when unauthorized distribution of content is discovered, the terminal-use playback information table, the playback control information and the individual terminal decryption key information tables can be generated such that, when playing, each of the plurality of specified playback apparatuses uses a unique device key not shared with any other playback apparatus. This means that when unauthorized distribution of the content occurs again, the playback apparatus that is the origin of unauthorized distribution can be specified.

Furthermore, when a playback apparatus group that shares device keys and another playback apparatus group that shares other device keys have a shared device key in common, using the common device key can reduce the amount of records and pieces of playback control information in the terminal-use playback information table, the amount of records in the individual terminal decryption key information table, and the amount of encrypted tracing data.

In the described NNL system, however, the device key allocated to each node is shared only between playback apparatuses holding device keys allocated to leaves below the particular node. By using a device key shared by playback apparatuses in a plurality of playback apparatus groups, the amount of data recorded on the recording medium can be reduced.

1.5 Playback Apparatuses 100a, 100b, . . . , 100c

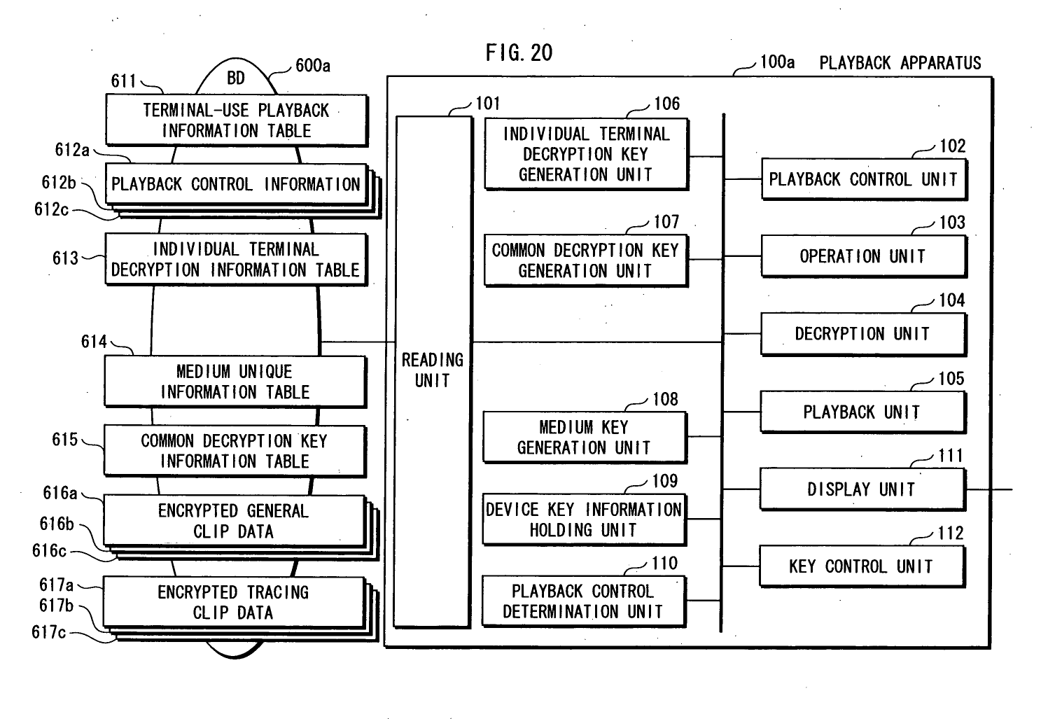

The playback apparatus 100a, as shown in FIG. 20, is composed of a reading unit 101, a playback control unit 102, an operation unit 103, a decryption unit 104, a playback unit 105, a individual terminal decryption key generation unit 106, a common decryption key generation unit 107, a medium key generation unit 108, a device key information holding unit 109, a playback control determination unit 110, a display unit 111, and a key control unit 112. A monitor 120a is connected to the playback apparatus 100a.

One example of an implementation of the playback apparatus 100a is a computer system composed of a CPU, a work memory, a flash memory, a BD drive, a remote controller, and a video adapter. The reading unit 101 is the BD drive; the operation unit 103 is the remote controller; the display unit 111 is the video adapter; the device key information holding unit 109 is the flash memory; and the playback control unit 102, the decryption unit 104, the playback unit 105, the individual terminal decryption key generation unit 106, the common decryption key generation unit 107, the medium key generation unit 108, the playback control information determination unit 110, and the key control unit 112 are embodied by software that operates using the CPU and the work memory, and achieve their functions by the CPU operating in accordance with computer programs.

Upon the BD 600a being mounted in the playback apparatus 100a by the user, the playback apparatus 100a decrypts and plays the content recorded on the BD 600a.

Note that since the playback apparatuses 100b, . . . , 100c have the same structure as the playback apparatuses 100a, a description thereof is omitted.

(1) Device Key Information Holding Unit 109

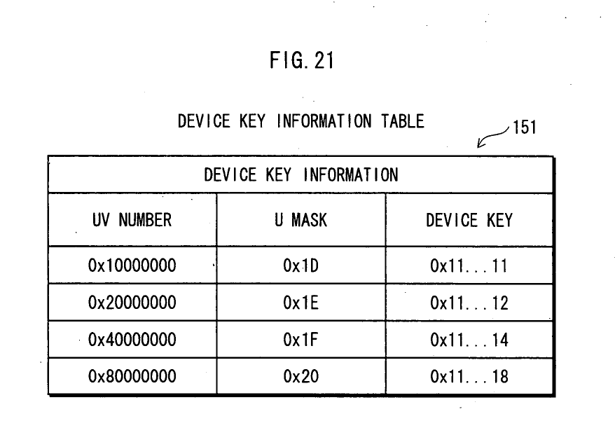

The device key information holding unit 109 stores, as one example, the device key information table 151 shown in FIG. 21.

The device key information table 151 includes a plurality of pieces of device key information, each of which includes a UV number, a U mask, and a device key.

In this way, the device key information table 151 stores a list of device keys that are each specified by a combination of a UV number and a U mask in the NNL system. Four device keys are written in the device key information table 151 shown in FIG. 21. The device key information table 151 shows, for instance, that the device key specified by the UV number “0x10000000” and the U mask “0x1D” is “0x11 . . . 11” (128 bits).

Note that each playback apparatus has one unique device key, and the remaining device keys are common to a plurality of playback apparatuses.

In this way, each playback apparatus holds a different plurality of device key (each 128 bits) to other playback apparatuses.

(2) Medium Key Generation Unit 108

The medium key generation unit 108 acquires the medium unique information table 614 from the BD 600a via the reading unit 101.

Next, the medium key generation unit 108 checks both the device key information table 151 held by the device key information holding unit 109 and the acquired medium unique key table 614 for any records that include a matching combination of a UV number and a U mask. When a matching combination exists, the medium key generation unit 108 extracts the device key information that includes the matching combination, extracts the device key from the extracted device key information, extracts the medium unique information that includes the matching combination from the medium unique information table 614, and extracts the encrypted medium key from the extracted medium unique information. Next, the medium key generation unit 108 decrypts the extracted encrypted medium key with use of the extracted device key, thereby generating a decrypted medium key.

In the NNL system, the device key allocated to a node able to be specified by the combination of the UV number and U mask can be used to calculate the device key allocated to a subordinate node thereof based on a set formula.

For this reason, even if a same combination does not exist, the decrypted medium key can be calculated when a node specified by the combination of the UV number and the U mask included in the device key information table 151 held by the device key information holding unit 109 exists on a path to the root from a node in the NNL system specified from the combination of the UV number and the U mask included in the medium unique key table 614. Using the device key in the record in the device key information table 151 held by the device key information holding unit 109, the medium key generation unit 108 calculates the device key allocated to the node specified from the combination of the UV number and the U mask included in the medium unique key table 614. Further, in the manner described above, the medium key generation unit 108 generates the decrypted medium key with use of the device key.

Note that the medium key generation unit 108 determines that the generation of the decrypted medium key has failed when both of the following occur: (a) a record having a matching combination of UV number and U mask exists in neither the device key information table 151 held by the device key information holding unit 109 nor in the acquired medium unique key table 614, and (b) a node specified by the combination of the UV number and the U mask included in the device key information table 151 held by the device key information holding unit 109 does not exist on a path to the root from a node in the NNL system specified from the combination of the UV number and the U mask included in the medium unique key table 614.

For instance, using the medium unique information table 614 shown in FIG. 18 and the device key information table 151 shown in FIG. 21, the combination of the UV number “0x10000000” and the U mask “0x1D” is included in both the medium unique information table 614 and the device key information table 151. Therefore, the medium key generation unit 108 uses the device key “0x11 . . . 11” corresponding to the UV number “0x10000000” and the U mask “0xD1” to decrypt the encrypted medium key “0x12 . . . 34” that corresponds to the UV number “0x10000000” and the U mask “0xD1”, and a decrypted medium key is generated successfully.

Here, when the decrypted medium key is generated successfully, the processing continues. On the other hand, when the generation of the decrypted medium key fails, this means that the playback apparatus 100a is in a revoked state due to being an unauthorized terminal, and therefore the processing ends.

When the decrypted medium key is generated successfully, the medium key generation unit 108 outputs the generated decrypted medium key to the common decryption key generation unit 107.

(3) Playback Control Information Determination Unit 110

The playback control information determination unit 110 acquires the terminal-use playback information table 611 from the BD 600a via the reading unit 101, and extracts, from each of the device key information table 151 and the terminal-use playback information table 611, a record in which (a) the U mask included in the device key information in the device key information table 151 held by the device key information holding unit 109 and (b) the U mask included in the terminal-use playback information in the acquired terminal-use playback information table 611 (in other words, the extracted records are a piece of device key information and a piece of the terminal-use playback information). The playback control information determination unit 110 searches the extracted records (the piece of device key information and the piece of the terminal-use playback information) for a record fulfilling the following:

{(UV number of terminal-use playback information in terminal-use playback information table 611) AND (V mask calculated from device key information in device key information table 151)}

={(UV number of device key information in device key information table 151) AND (V mask calculated from device key information in device key information table 151)}

Here, “AND” is an operator showing a logical product.

When a record fulfilling the described condition exists, the playback control information determination unit 110 extracts the piece of terminal-use playback information that fulfills the condition from the terminal-use playback information table 611, and extracts the playback control information ID from the extracted terminal-use playback information. The playback control information determination unit 110 also extracts the device key information that fulfills the condition from the device key information table 151, extracts the device key from the extracted device key information, and determines the device key extracted in this way to be a playback-use device key.

A specific example is described using the terminal-use playback information table shown in FIG. 15 and the device key information table 151 shown in FIG. 21.

The record (piece of device key information) that includes the UV number “0x10000000” and the U mask “0xD1” in the device key information table 151 shown in FIG. 21 is focused on here. The V mask calculated from this UV number based on the described formula is “0xF0000000”.

In the terminal-use playback information table 611 shown in FIG. 15, two records (pieces of terminal-use playback information) that include the U mask “0x1D”, and the UV numbers thereof are (1) “0x10000000” and (2) “0x20000000”. Evaluating the aforementioned condition using the V mask calculated from the piece of device information, results in the following:

(1) {(UV number of piece of terminal-use playback information) AND (V mask calculated from piece of device key information)}

=(0x10000000 AND 0xF0 . . . 00)

(2) {(UV number of piece of terminal-use playback information) AND (V mask calculated from piece of device key information)}

=(0x20000000 AND 0xF0 . . . 00)

{(UV number of piece of device key information) AND (V mask of piece of device key information)}

=(0x10000000 AND 0xF0 . . . 00)

Therefore, (1) is the corresponding record. In other words, (1) is the record corresponding to the piece of terminal-use playback information that includes the UV number “0x10000000” and the U mask “0x1D”, and the piece of device key information that includes the UV number “0x10000000” and the U mask “0x1D”.

Therefore, the playback control information determination unit 110 extracts the piece of terminal-use playback information that includes UV number “0x10000000” and the U mask “0x1D” from the terminal-use playback information table 611, and extracts the playback control information ID “0x01” from the extracted playback control information. In this way the playback control information determination unit 110 determines the playback control information ID to be “0x01”. Next, the playback control information determination unit 110 outputs the determined playback control information ID to the playback control unit 102. The playback control information determination unit 110 also extracts the piece of device key information that includes the UV number “0x10000000” and the U mask “0x1D” from the device key information table 151, and extracts the device key “0x11 . . . 11” from the extracted device key information. In this way, the playback control information determination unit 110 determines to use the device key “0x11 . . . 11” as the playback-use device key, and outputs the determined playback-use device key to the individual terminal decryption key generation unit 106.

Furthermore, when a record that fulfills the aforementioned condition does not exist, the playback control information determination unit 110 checks whether or not a node specified by the combination of the UV number and the U mask in the device key information table 151 held by the device key information holding unit 109 exists on a path from the root to the node in the NNL system specified from the combination of the UV number and the U mask in the terminal-use playback information table 611. When such a node exists, the playback control information determination unit 110 calculates, from the device key allocated to the specified node which is in the piece of device key information held by the device key information holding unit 109, a device key allocated to anode specified by the combination of the UV number and the U mask in the terminal-use playback information table 611, and determines the calculated device key to be the playback-use device key. The playback control information determination unit 110 further determines a playback control information ID from the record in the terminal-use playback information table 611. When the specified node does not exist on a path from the root to the node in the NNL system specified from the combination of the UV number and the U mask in the terminal-use playback information table 611, the processing ends.

(4) Individual Terminal Decryption Key Generation Unit 106

The individual terminal decryption key generation unit 106 acquires the individual terminal decryption key information table 613 from the BD 600a via the reading unit 101, and extracts, from the acquired individual terminal decryption key information table 613, a piece of individual terminal decryption key information that includes the same combination as the combination of UV number and U mask that specify the device key used in playback determined by the playback control information determination unit 110. The individual terminal decryption key generation unit 106 then extracts the 15 encrypted decryption keys from the extracted individual terminal decryption key information.

Next, the individual terminal decryption key generation unit 106 receives the device key used in playback from the playback control information determination unit 110, decrypts each of the 15 extracted encrypted decryption keys using the received device key, thereby generating 15 individual terminal decryption key, and outputs the generated individual terminal decryption keys to the key control unit 112.

A specific example is described using the individual terminal decryption key information table 613 shown in FIG. 17.

When the device key determined by the playback control information determination unit 110 is specified in the device key information table 151 by the UV number “0x10000000” and the U mask “0x1D”, the individual terminal decryption key generation unit 106 acquires the 15 encrypted device keys identified by the key IDs “0xF111” to “0xF11F”, respectively, in the individual terminal decryption key information table 613. Next, decrypts each of the acquired 15 encrypted decryption keys using the device key “0x11 . . . 11” determined in the playback control information determination unit 110, thereby generating 15 individual terminal decryption keys.

(5) Playback Control Unit 102

The playback control unit 102 receives the playback control information ID from the playback control information determination unit 110, and via the reading unit 101, acquires a piece of playback control information corresponding to the received playback control information ID from among the pieces of playback control information 612a, 612b, . . . , 612c recorded on the BD 600a.

Specifically, when the playback control information ID received from the playback control information determination unit 110 is “0x01”, the playback control unit 102 acquires the playback control information 612a shown in FIG. 16. The playback control information 612a includes the playback control information ID “0x01”.

The playback control unit 102 extracts one piece at a time of the playback order information included in the acquired piece of playback control information, in accordance with the order in which the pieces of playback order information are arranged in the piece of playback control information.

The playback control unit 102 extracts the clip data name from the extracted piece of playback order information, and extracts the decryption key ID. Next, the playback control unit 102 judges whether or not the extracted decryption key ID includes a designation of a key ID. Specifically, when the extracted decryption key ID is “-”, the playback control unit 102 judges that the key ID is not designated. When the decryption key ID is not “-”, the playback control unit 102 judges that the key ID is designated.

When it is judged that the key ID is not designated, the playback control unit 102 controls the key control unit 112 and the decryption unit 104 so as to decrypt the encrypted clip data shown by the clip data name (in this case, encrypted general clip data) with a common decryption key.

When it is judged that the key ID is designated, the playback control unit 102 controls the key control unit 112 so as to acquire the individual terminal decryption key corresponding to the decryption key ID, and controls the decryption unit 104 so as to decrypt the encrypted clip data shown by the clip data name (in this case, encrypted tracing clip data) with the individual terminal decryption key.

Next, the playback control unit 102 controls the playback unit 105 and the display unit 111 to play and display the decrypted clip data.

When control for the described judgment, decryption, playback and display is complete for all extracted pieces of playback order information, and playback of all clip data ends, content playback ends.

A specific example is described using the playback control information 612a shown in FIG. 16.

The playback control information 612a stores pieces of playback order information 661, 662, 663, . . . , 664 in the stated order. Therefore, the playback control unit 102 controls such that the pieces of encrypted clip data designated by the pieces of playback order information 661, 662, 663, . . . , 664 are decrypted, played and displayed in the stated order of the pieces of the playback order information.

First, the playback control unit 102 controls so that the decryption and playback of the encrypted clip data “Clip001.m2ts” written in the playback order information 661 are performed. Here, the playback control unit 102 controls the key control unit 112 so as to output a common decryption key, in accordance with the playback control information 612a, to the decryption unit 104. Next, the playback control unit 102 controls decryption unit 104 so as to decrypt the encrypted clip data using the received common decryption key. The playback control unit 102 then controls the playback unit 105 so as to play the clip data and controls the display unit 111 so as to output.

Upon playback of the encrypted clip data “Clip001.m2ts”, the playback control unit 102, in order to decrypt the encrypted clip data “Clip101.m2ts” written in the playback order information 662 arranged next, in accordance with the playback control information 612a, causes the key control unit 112 to transmit the individual terminal decryption key shown by the key ID “0xF111” included in the playback control information 662 to the decryption unit 104, controls the decryption unit 104 so as to decrypt the encrypted clip data “Clip101.m2ts” using the received decryption key, controls the playback unit so as to play the clip data, and controls the display unit 111 so as to output. This processing is the same for the subsequent pieces of playback order information 663, . . . , 664.

Note that when a piece of playback order information includes a playback control information ID identifying a different piece of playback control information, thus indicating that the different piece of playback control information is to be referred to, the playback control unit 102 reads the piece of playback control information indicated by the designated playback control information ID from the BD 600a, and continues playback in accordance with the read piece of playback control information in the manner described above.

Furthermore, in the present embodiment, when commencing playback, playback control information corresponding to the playback apparatus is determined, and content is played using the determined playback control information. However, the present embodiment is not limited to this structure. For instance, playback may be performed initially using common playback control information in all playback apparatuses, and then subsequently with each playback apparatus using playback control information corresponding to the playback control information ID determined by the playback control information determination unit 110 of the particular playback apparatus.

Note that although in the present embodiment, playback is described as ending when all clip data written in the playback control information 612a ends, playback may end at the point in time at which a playback stop instruction is received.

(6) Common Decryption Key Generation Unit 107

The common decryption key generation unit 107 receives a key ID from the playback control unit 102.

Upon receiving the key ID, the common decryption key generation unit 107 acquires, via the reading unit 101, the encrypted decryption key corresponding to the received key ID, from the common decryption key information table 615 recorded on the BD 600a.

Next, the common decryption key generation unit 107 receives a decrypted medium key from the medium key generation unit 108, decrypts the acquired encrypted decryption key using the received decrypted medium key, thereby generating a common decryption key, and outputs the generated common decryption key to the key control unit 112.

A specific example is described.

When a key ID “0x0101” is received from the playback control unit 102, the common decryption key generation unit 107 acquires, from among the pieces of common decryption key information included in the common decryption key information table 615 shown in FIG. 19, a piece of common decryption key information that includes an identical key ID to the received key ID “0x0101”, extracts the encrypted decryption key “0xFF. DC” from the acquired common decryption key information, decrypts the encrypted decryption key “0xFE . . . DC” using the decrypted medium key received from the medium key generation unit 108, and generates a common decryption key.

(7) Decryption Unit 104

The decryption unit 104 receives clip data that is a decryption target from the playback control unit 102, receives a decryption key from the key control unit 112, decrypts the encrypted clip data shown by the received clip data name, by decrypting the transport stream packet by packet using the received decryption key, and outputs the decrypted packets to the playback unit 105.

Note that decryption keys may be switched between each packet of the transport stream. In this case, the decryption unit 104 switches the decryption key by using a scramble control flag included in each packet of the transport stream in the encrypted clip data that is the decryption target.

In the decryption of encrypted clip data, when playing in alternation general clip data using a common decryption key and encrypted tracing clip data that uses an individual terminal decryption key which is not a common decryption key, the type of decryption key for each packet in the transport stream in each encrypted clip data is distinguished using the scramble control flag in the packet.

For instance, the scramble control flag may be set to “0x00” for packets encrypted with a common decryption key, and to “0x01” for packets encrypted with a decryption key that is not a common decryption key. When decrypting encrypted data, the decryption unit switches the decryption key in accordance with the scramble control flag.

Furthermore, in the above the decryption unit 104 is not limited to decrypting a transport stream in units of packets, and may decrypt in other units.

(8) Key Control Unit 112

The key control unit 112 receives a common decryption key from the common decryption key generation unit 107, and receives 15 individual terminal keys from the individual terminal decryption key generation unit 106.

Next, the key control unit receives a designation of one decryption key from among the received common decryption key and the 15 individual terminal decryption keys, and outputs the decryption key shown by the received designation to the decryption unit 104.

(9) Playback Unit 105, Display Unit 111, Monitor 120a, and Operation Unit 103

The playback unit 105 receives decrypted clip data from the decryption unit 104, and plays the received clip data, to generate a digital video signal and a digital audio signal.

The display unit 111 receives the digital video signal and audio signal, and converts the received digital video signal and audio signal into an analog video signal and audio signal which is output to an external apparatus. Here, one example of the external apparatus is the monitor 120a, and another example is the recording apparatus 500.

The monitor 120a receives the analog audio and video signals, and displays video and outputs audio.

The operation unit 103 receives a user instruction, and outputs instruction information corresponding to the received user instruction to the compositional units.

1.6 Operations of the Playback Apparatus 100a

A description is given of the operations of the playback apparatus 100a.

(1) Overview of Operations of the Playback Apparatus 100a

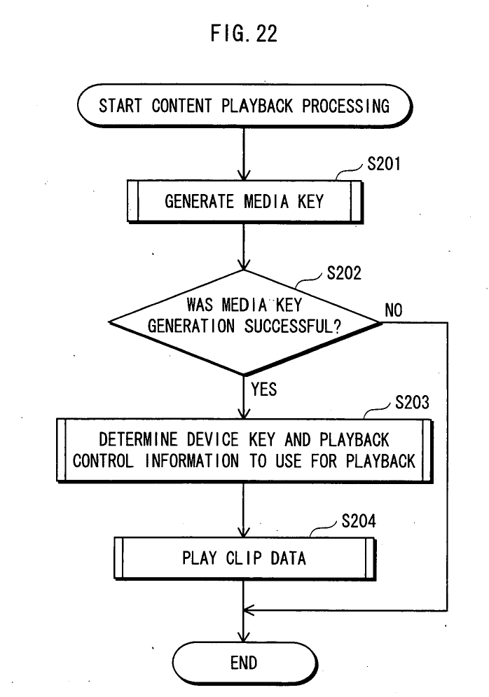

An overview of operations of the playback apparatus 100a is given using the flowchart shown in FIG. 22.

Upon the BD 600a being mounted in the playback apparatus 100a by the user, the medium key generation unit 108 acquires the medium unique information table 614 from the BD 600a via the reading unit 101, and attempts to generate a decrypted medium key (step S201).

When a decrypted medium key is successfully generated (step S202), the playback control information determination unit 110 determines a device key to be used in playback of content (step S203), and the decryption unit 104 and the playback unit 105 play clip data (step S204). When playback of all encrypted clip data written in the playback control information 612a ends, playback processing ends.

On the other hand, when generation of a decrypted medium key fails (step S202), this means that the playback apparatus 100a is in a revoked state due to being an unauthorized terminal, and the playback apparatus 100a ends the playback processing.

(2) Operations by the Medium Key Generation Unit 108 for Generating a Medium Key

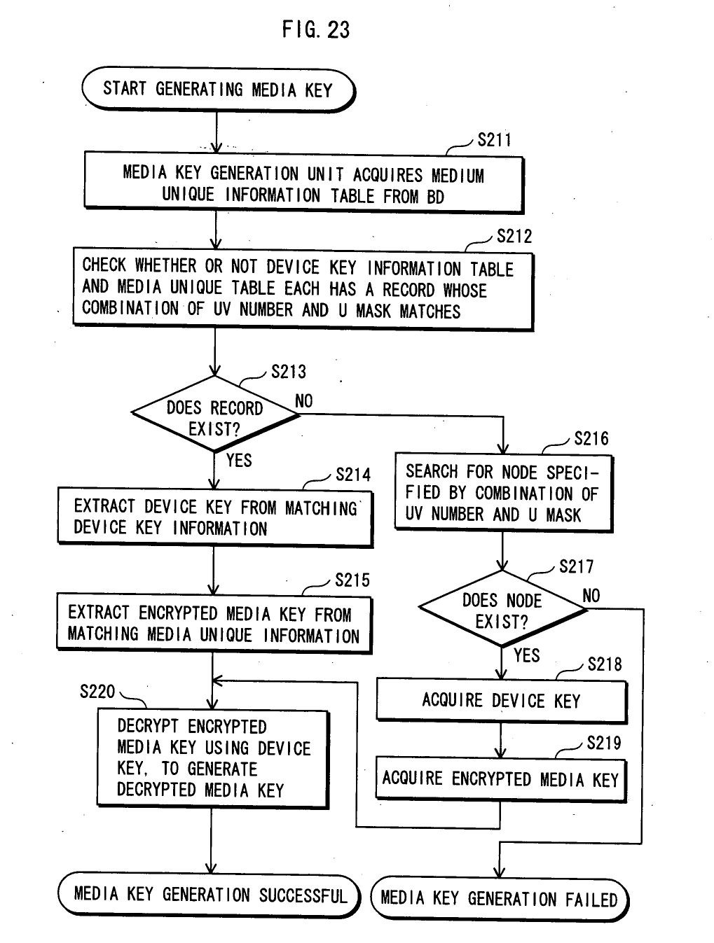

A description is given of operations by the medium key generation unit 108 for generating a medium key, with use of the flowchart shown in FIG. 23. Note that the operations for generating the medium key described in the following are the details of step S201 shown in FIG. 22.

The medium key generation unit 108 acquires the medium unique information table 614 from the BD 600a via the reading unit 101 (step S211).

Next, the medium key generation unit 109 checks whether records having a matching combination of UV number and U mask exist in both the device key information table 151 held by the device key information holding unit 109 and the acquired medium unique key table 614 (step S212). When the same combination exists (YES at step S213), the medium key generation unit 108 extracts the piece of device key information that includes the matching combination from the device key information table 151, extracts the device key from the extracted device key information (step S214), extracts the piece of medium unique information that includes the matching combination from the medium unique information table 614, and extracts the encrypted medium key from the extracted medium unique information (step S215). Next, the medium key generation unit 108 decrypts the extracted encrypted medium key using the extracted device key, and generates a decrypted medium key (step S220).

When the same combination does not exist (NO at step S213), the medium key generation unit 108 searches for a node specified by the combination of the UV number and the U mask included in the device key information table 151 held by the device key information holding unit 109 exists on a path to the root from a node in the NNL system specified from the combination of the UV number and the U mask included in the medium unique key table 614 (step S216). When such a node exists (YES at step S217), using the device key in the record in the device key information table 151 held by the device key information holding unit 109, the medium key generation unit 108 calculates the device key allocated to the node specified from the combination of the UV number and the U mask included in the medium unique key table 614 (step S218), acquires an encrypted medium key (step S219), and in the manner described above, generates a decrypted medium key with use of the device key (step S220).

When a record having a matching combination of UV number and U mask exists in neither the device key information table 151 held by the device key information holding unit 109 nor in the acquired medium unique key table 614 (NO at step S213), and a node specified by the combination of the UV number and the U mask included in the device key information table 151 held by the device key information holding unit 109 does not exists on a path to the root from a node in the NNL system specified from the combination of the UV number and the U mask included in the medium unique key table 614 (NO at step S217), the medium key generation unit 108 determines that the generation of the decrypted medium key has failed.

(3) Operations by the Playback Control Information Determination Unit 110 for Determining Playback Control Information

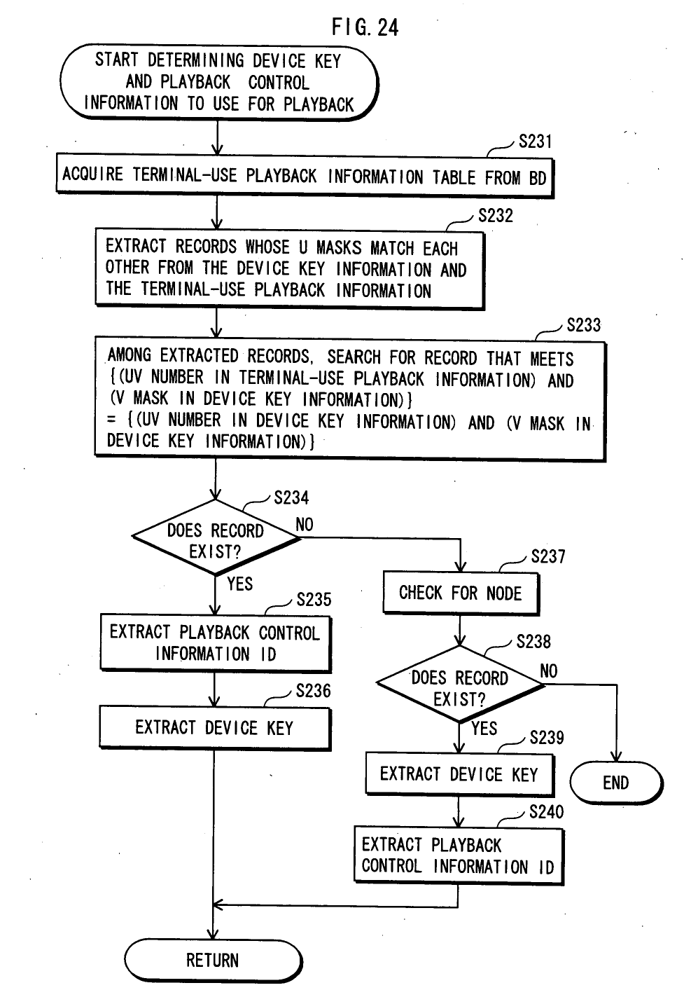

A description is given of operations by the playback control information determination unit 110 determining playback control information, with use of the flowchart shown in FIG. 24. Note that the operations for determining the playback control information described in the following are the details of step S203 shown in FIG. 22.

The playback control information determination unit 110 acquires the terminal-use playback information table 611 from the BD 600a (step S231), and extracts, from each of the device key information table 151 and the terminal-use playback information table 611, a record in which (a) the U mask included in the device key information in the device key information table 151 held by the device key information holding unit 109 and (b) the U mask included in the terminal-use playback information in the acquired terminal-use playback information table 611 (in other words, the extracted records are a piece of device key information and a piece of the terminal-use playback information) (step S232). The playback control information determination unit 110 searches the extracted records (the piece of device key information and the piece of the terminal-use playback information) for a record fulfilling the following:

{(UV number of terminal-use playback information in terminal-use playback information table 611) AND (V mask calculated device key information in device key information table 151)}

={(UV number of device key information in device key information table 151) AND (V mask calculated from device key information in device key information table 151)} (step S233).

When a record fulfilling the described condition exists (YES at step S234), the playback control information determination unit 110 extracts the piece of terminal-use playback information that fulfills the condition from the terminal-use playback information table 611, and extracts the playback control information ID from the extracted terminal-use playback information (step S235). The playback control information determination unit 110 also extracts the piece of device key information that fulfills the condition from the device key information table 151, extracts the device key from the extracted piece of device key information, and determines the device key extracted in this way to be a playback-use device key (step S236).

When a record that fulfills the aforementioned condition does not exist (NO at step S234), the playback control information determination unit 110 checks whether or not a node specified by the combination of the UV number and the U mask in the device key information table 151 held by the device key information holding unit 109 exists on a path from the root to the node in the NNL system specified from the combination of the UV number and the U mask in the terminal-use playback information table 611 (step S237). When such a node exists (YES at step S238), the playback control information determination unit 110 calculates, from the device key allocated to the node which is in the piece of device key information held by the device key information holding unit 109, a device key allocated to a node specified by the combination of the UV number and the U mask in the terminal-use playback information table 611, and determines the calculated device key to be the playback-use device key (step S239). The playback control information determination unit 110 further determines a playback control information ID from the record in the terminal-use playback information table 611 (step S240). When a node specified by the combination of the UV number and the U mask in the device key information table 151 held by the device key information holding unit 109 does not exist on a path from the root to the node in the NNL system specified from the combination of the UV number and the U mask in the terminal-use playback information table 611 (NO at step S238), the processing ends.

(4) Operations for Playing of Clip Data

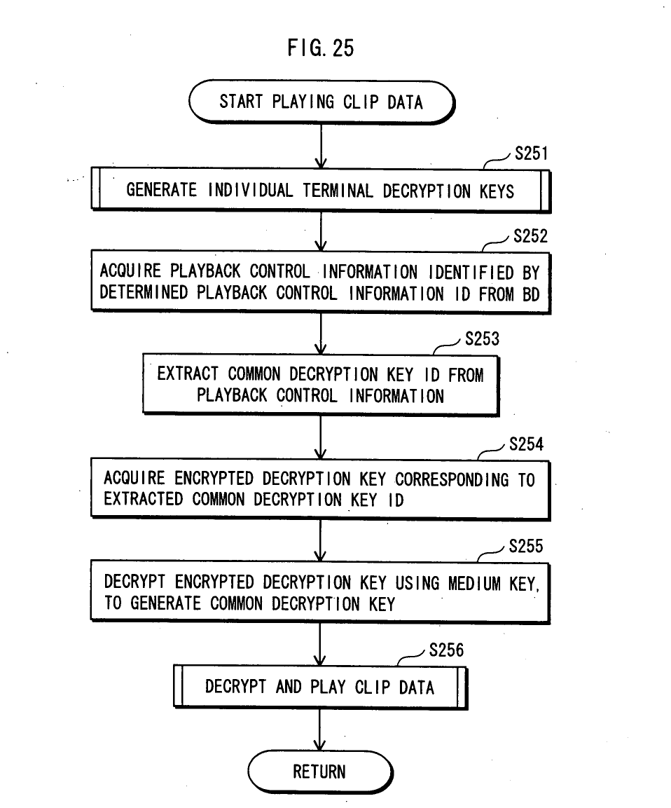

A description of operations for playing clip data is given with use of the flowchart shown in FIG. 25. Note that the operations for playing clip data described in the following are the details of step S204 shown in FIG. 22.

The individual terminal decryption key generation unit 106 acquires the individual terminal decryption key information table 613 from the BD 600a, and generates an individual terminal decryption key for use in playback (step S251).

Next, the playback control unit 102 acquires the piece of playback control information corresponding to the determined playback control information ID from the BD 600a via the reading unit 101 (step S252).

Next, the playback control unit 102 extracts a common decryption key ID from the piece of playback control information (step S253), the common decryption key generation unit 107 acquires the encrypted decryption key corresponding to the extracted common decryption key ID (step S254), and decrypts the encrypted decryption key with use of the decrypted medium key, to generate a common decryption key (step S255).

Next, the playback control unit 102 acquires pieces of encrypted clip data from the BD 600a in the order written in the piece of playback control information, and controls the decryption unit 104, the playback unit 105, and the display unit 111 so as to decrypt, playback and display, with use of the key corresponding to the designated decryption key ID (step S256).

(5) Operations for Generating the Individual Terminal Decryption Key

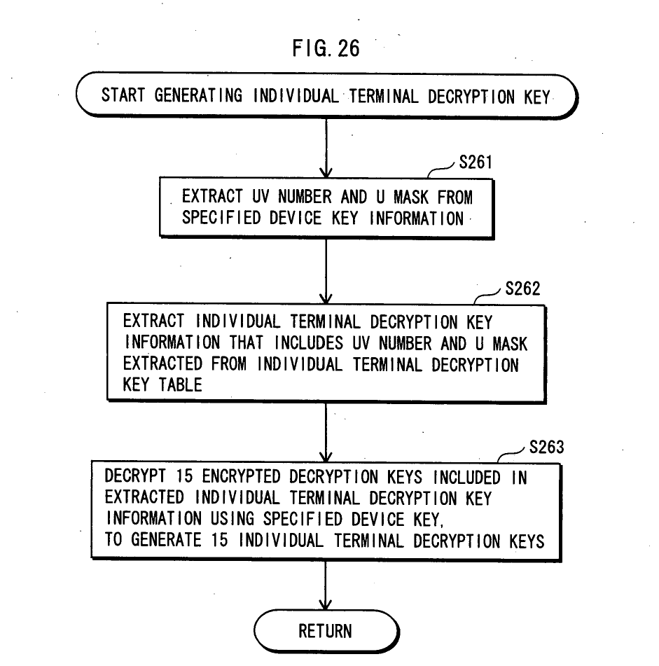

A description of operations for generating the individual terminal decryption key is given with use of the flowchart shown in FIG. 26. Note that the operations for playing clip data described in the following are the details of step S251 shown in FIG. 25.

The individual terminal decryption key generation unit 106 extracts the combination of the UV number and the U mask from the specified piece of device key information (step S261), acquires the individual terminal decryption key information table 613 from the BD 600a via the reading unit 101, and extracts, from the acquired individual terminal decryption key information table 613, a piece of individual terminal decryption key information that includes the same combination as the combination of UV number and U mask that specify the device key used in playback determined by the playback control information determination unit 110. The individual terminal decryption key generation unit 106 then extracts the 15 encrypted decryption keys from the extracted piece of individual terminal decryption key information (step S262).

Next, the individual terminal decryption key generation unit 106 receives the device key used in playback from the playback control information determination unit 110, decrypts each of the 115 extracted encrypted decryption keys using the received device key, thereby generating 15 individual terminal decryption key, and outputs the generated individual terminal decryption keys to the key control unit 112 (step S263).

(6) Operations for Decryption and Playback of Clip Data

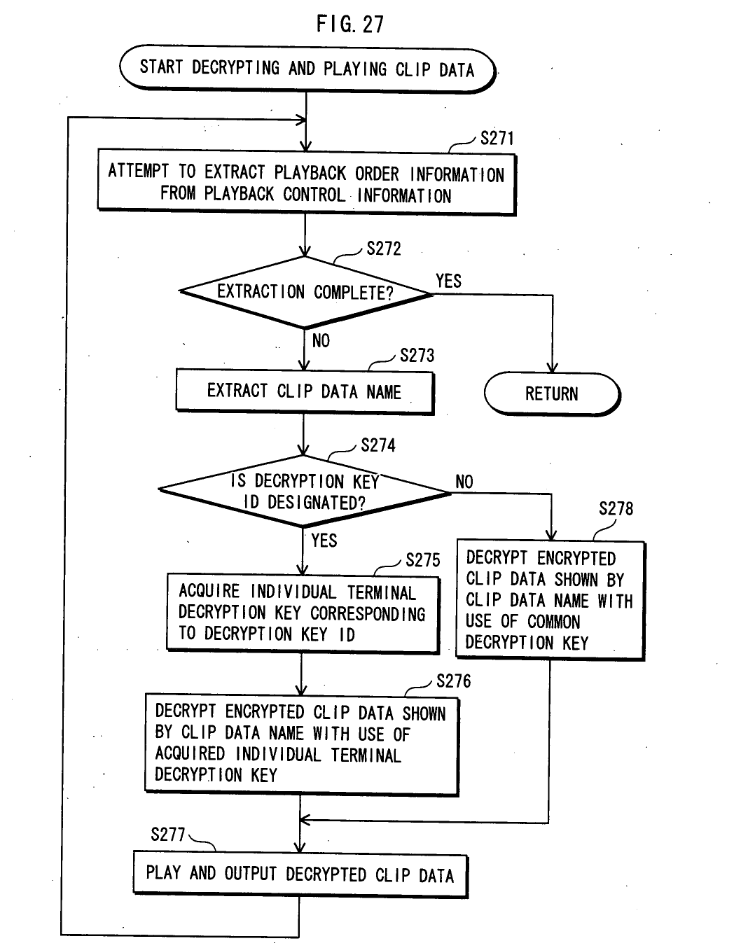

A description of operations for decryption and playback of clip data is given with use of the flowchart shown in FIG. 27. Note that the operations for playing clip data described in the following are the details of step S256 shown in FIG. 25.

The playback control unit 102 extracts one piece at a time of the pieces of playback order information included in a piece of playback control information (step S271).

When all the pieces have been extracted (YES at step S272), the operations for decrypting and playing clip data end.

When all the pieces have not been extracted (NO at step S272), the playback control unit 102 extracts the clip data name from the extracted piece of playback order information, and extracts the decryption key ID (step S273). Next, the playback control unit 102 judges whether not the extracted decryption key ID includes a designation of a key ID (step S274).

When it is judged that the key ID is not designated (step S274), the playback control unit 102 controls the key control unit 112 and the decryption unit 104 so as to decrypt the encrypted clip data shown by the clip data name (in this case, encrypted general clip data) with a common decryption key (step S278).

When it is judged that the key ID is designated (step S274), the playback control unit 102 controls the key control unit 112 so as to acquire the individual terminal decryption key corresponding to the decryption key ID (step S275), and controls the decryption unit 104 so as to decrypt the encrypted clip data shown by the clip data name (in this case, encrypted tracing clip data) with the individual terminal decryption key (step S276).

Next, the playback control unit 102 controls the playback unit 105 and the display unit 111 to play and display the decrypted clip data (step S277).

1.7 Recording Apparatus

The recording apparatus is connected to the playback apparatus 10b. The recording apparatus 500 receives an analog video signal and audio signal from the playback apparatus 100b, converts the received video signal and audio signal to digital video information and audio information, compression encodes the video information and audio information, and encrypts the compression encoded video information and audio information, thereby generating encrypted content. Next, the recording apparatus 500 writes the encrypted content to the BD 650a.

1.8 Inspection Apparatus 400

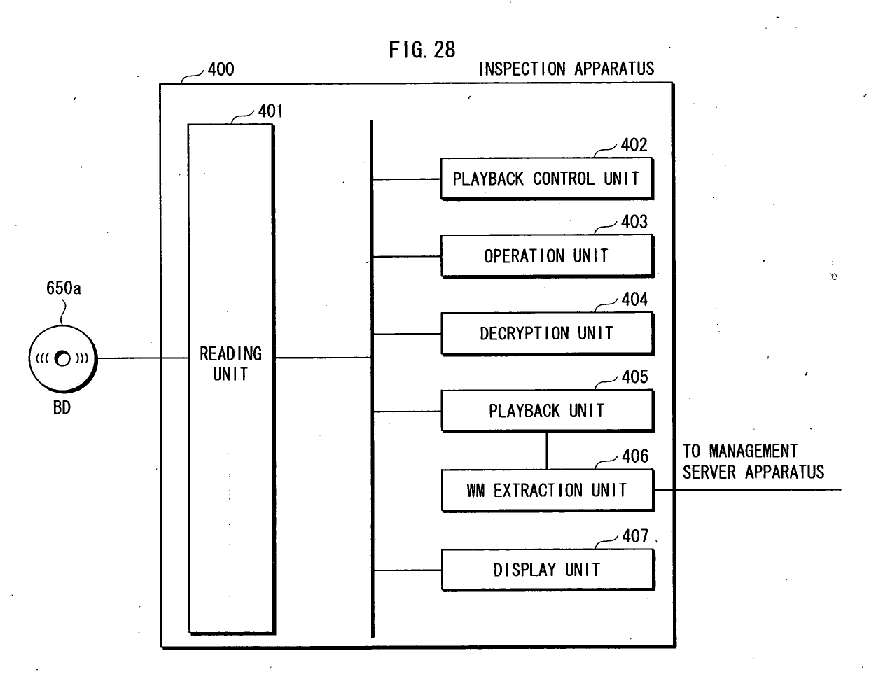

The inspection apparatus 400, as shown in FIG. 28, is composed of a reading unit 401, a playback control unit 402, an operation unit 403, a decryption unit 404, a playback unit 405, a WM extraction unit 406, and a display unit 407.

The inspection apparatus 400 is, specifically, a computer system composed of a microprocessor, a ROM, a RAM, a hard disk unit, a communication unit, a display unit, a keyboard, a mouse and the like. Computer programs are stored in the RAM or the hard disk unit, and the inspection apparatus 400 achieves part of its functions by the microprocessor operating in accordance with the computer programs.

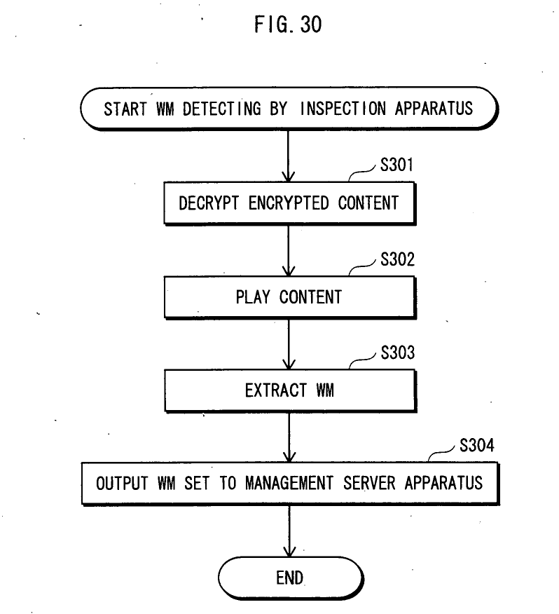

The following description is given with use of the flowchart shown in FIG. 30.

The decryption unit 404 reads the encrypted content from the BD 650a via the reading unit 401, decrypts the read encrypted content, generates decrypted content, and outputs the generated decrypted content to the playback unit 405 (step S301).

The playback unit 405 extracts digital audio information from the decrypted content, converts the extracted audio information to an analog audio signal, and outputs the audio signal to the WN extraction unit 406 (step S302).

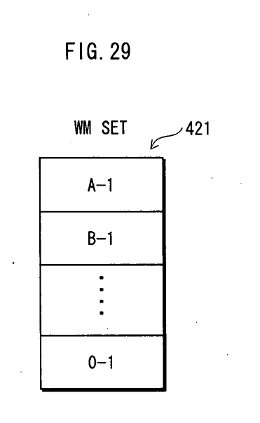

The WM extraction unit 406 extracts a WM set from the audio signal (step S303). For instance, When the extracted WM set is that of the playback path 297 shown in FIG. 6, the WM set is the WM set 421 {“A-1”, “B-1”, . . . , “O-1”} shown in FIG. 29, and when the extracted WM set is that of the playback path 298 shown in FIG. 6, the WM set is {“A-2”, “B-3”, . . . , “O-3”}.

The WM extraction unit 406 transmits the extracted WM set to the management server apparatus 200 via the dedicated line 200 (step S304).

### 2. Modification

A description is given of a content distribution system 10a as an example of a modification of the content distribution system 10 given as the above embodiment.

Similar to the content distribution system 10, the content distribution system 10a is composed of a management server apparatus 200, a manufacturing apparatus 300, playback apparatuses 100a, 100b, . . . , 100c, a recording apparatus 500, and an inspection apparatus 400. The apparatuses in the content distribution system 10a have substantially the same structure as those in the content distribution system 10.

Although the management server apparatus 200 in the content distribution system 10 manages the playback apparatuses using a tree structure, the management server apparatus 200 in the content distribution system 10a manages the terminal apparatuses without a tree structure. This is the only difference between the two systems.

The following describes only the aspects that differ.

2.1 Information Storage Unit 201

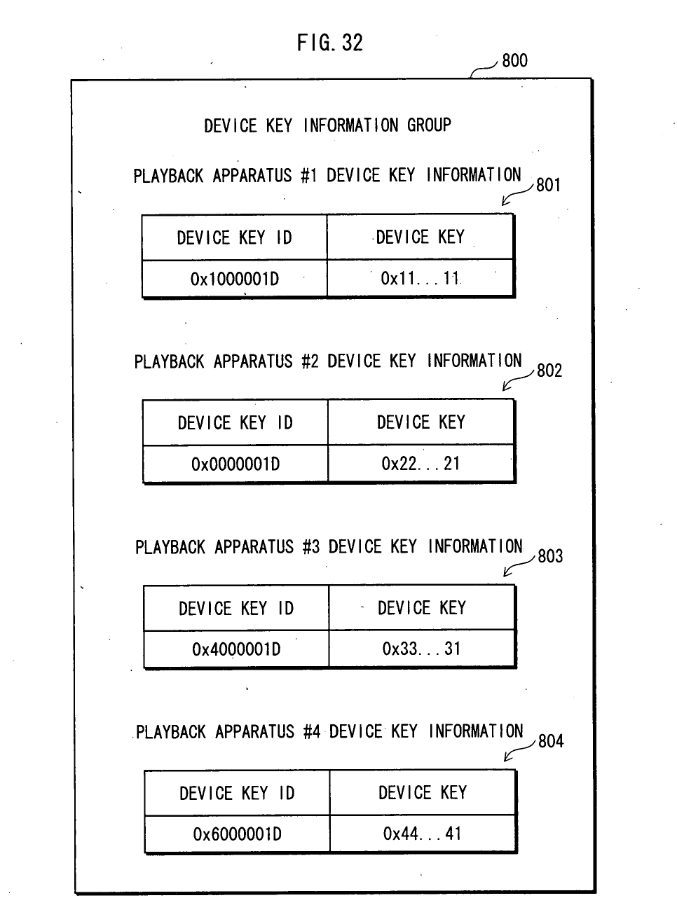

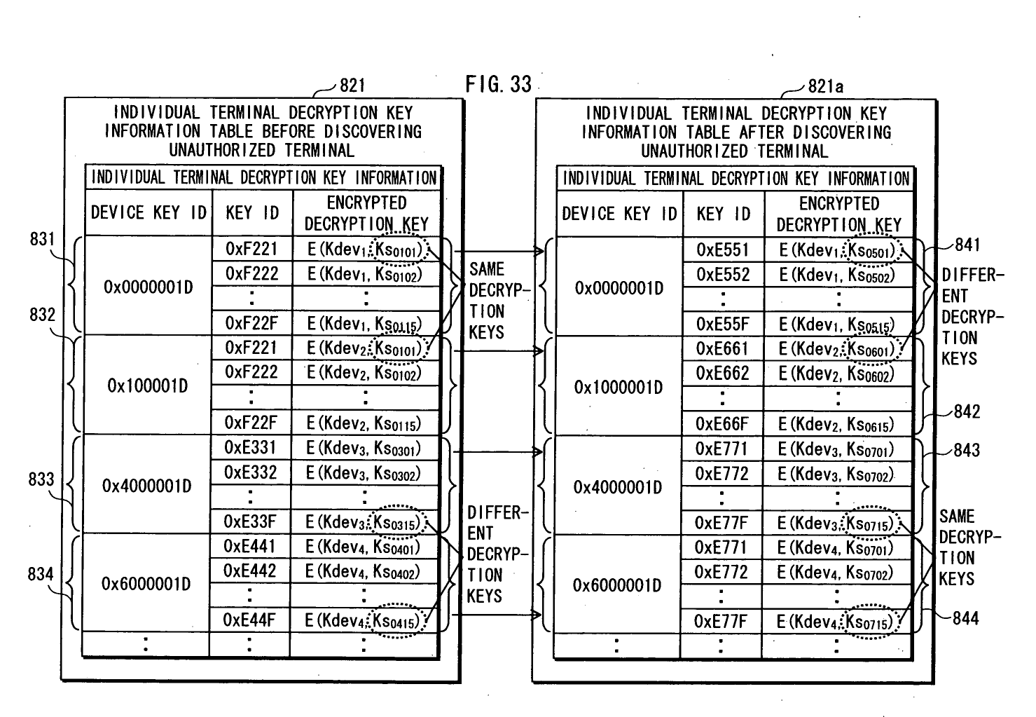

The information storage unit 201 in the management server apparatus 200 in the content distribution system 10a stores a device key information group 800 shown in FIG. 32, instead of the device key information table group 211, and an individual terminal decryption key information group 821 shown in FIG. 33, instead of the individual terminal decryption key information table 214.

(Device Key Information Group 800)

The device key information group 800 includes pieces of device key information 801, 802, . . . , 803, . . . , 804, . . .

The pieces of device key information 801, 802, . . . , 803, . . . , 804, . . . correspond respectively to the playback apparatuses 100a, 100b, . . . , 100c.

Each piece of device key information is composed of a device key ID and a device key.

The device key ID is identification information that uniquely identifies the piece of device key information that includes the device key ID.

The device key is key information allocated to the playback apparatus corresponding to the piece of device key information that includes the device key.

(Individual Terminal Decryption Key Information Table 821)

The individual terminal decryption key information table 821, as shown in FIG. 33, is composed of a plurality of pieces of individual terminal decryption information. The pieces of individual terminal information correspond one-to-one to the playback apparatuses 100a, 100b, . . . , 100c.

Each piece of individual terminal decryption key information is composed of a device key ID and 15 key information sets. Each key information set is composed of a key ID and an encrypted decryption key.

The device ID, as described above, is identification information that uniquely identifies the piece of device key information. Here, since the piece of device key information and the piece of individual terminal decryption key information correspond to a particular playback apparatus, the device key ID uniquely identifies the piece of individual terminal decryption key information that includes the device key ID.

The key ID is identification information that uniquely identifies the key information set that includes the device key ID.

The encrypted decryption key has been generated by encrypting a decryption key with use of a device key allocated to a playback apparatus corresponding to the piece of individual terminal decryption key information that includes the encrypted decryption key.

The 15 decryption keys used as a basis when generating the encrypted decryption keys included respectively in the 15 pieces of encrypted decryption key information are respectively different.

However, the 15 decryption keys used as a basis when generating the encrypted decryption keys in the 15 key information sets in the piece of individual terminal decryption key information 831 are respectively identical to the 15 decryption keys used as a basis when generating the encrypted decryption keys included in the 15 key information sets in the piece of individual terminal decryption key information 832.

Furthermore, the 15 decryption keys used as a basis when generating the encrypted decryption keys included in the 15 key information sets in the piece of individual terminal decryption key information 831 are different to the 15 decryption keys used as a basis when generating the encrypted decryption key included in the key information sets in the piece of individual terminal decryption key information 833. The 15 decryption keys used as a basis when generating encrypted decryption keys included in the 15 key information sets in the piece of individual terminal decryption key information 833 are different to the 15 decryption keys used as a basis when generating the encrypted decryption keys included in the decryption key information sets in the piece of individual terminal decryption key information 834.

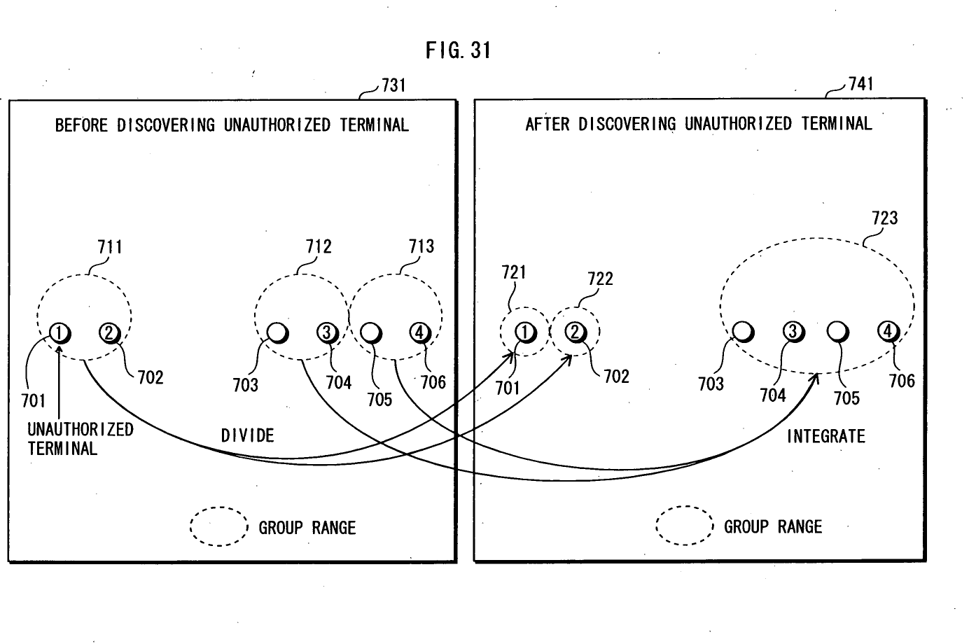

As shown in FIG. 31, the playback apparatus 701 that corresponds to the piece of individual terminal decryption key information 831 and the playback apparatus 702 that corresponds to the piece of individual terminal decryption key information 832 belong to the same group 711. This also shows that playback apparatus 701 that corresponds to the piece of individual terminal decryption key information 831 and the playback apparatus 704 that corresponds to the piece of individual terminal decryption key information 833 belong to different groups, namely, the group 711 and the group 712, respectively. In addition, this shows that the playback apparatus 704 that corresponds to the piece of individual terminal decryption key information 833 and the playback apparatus 706 that corresponds to the piece of individual terminal decryption key information 834 belong to different groups, namely, the group 712 and the group 713, respectively.

2.2 Re-Formation Unit 204

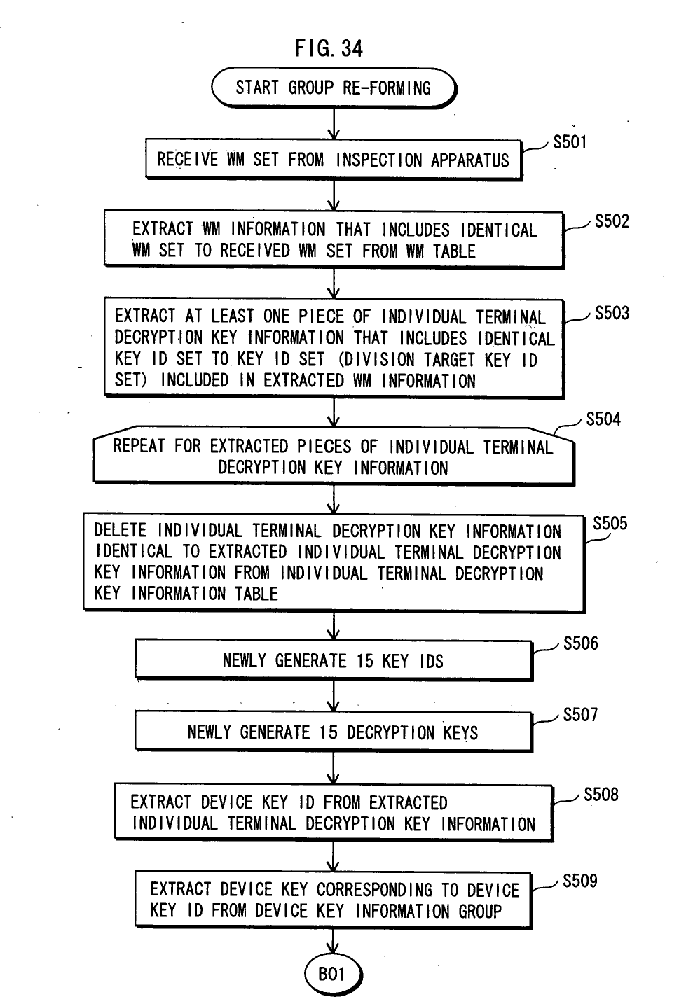

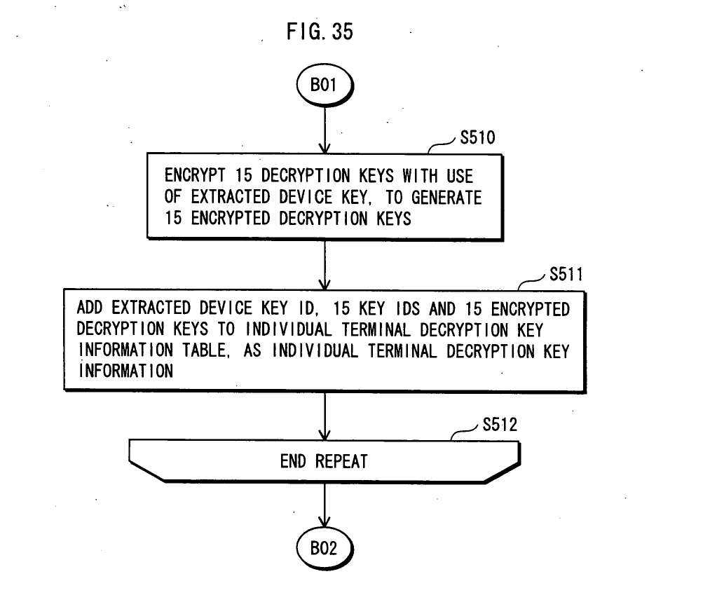

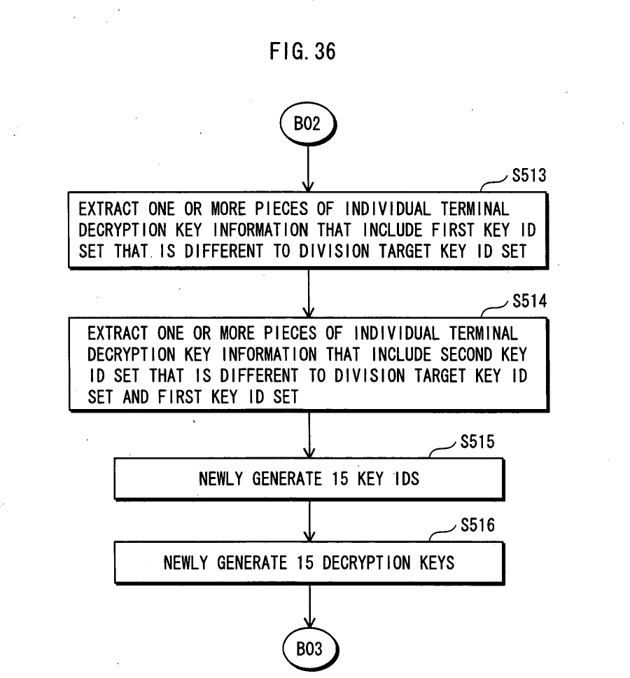

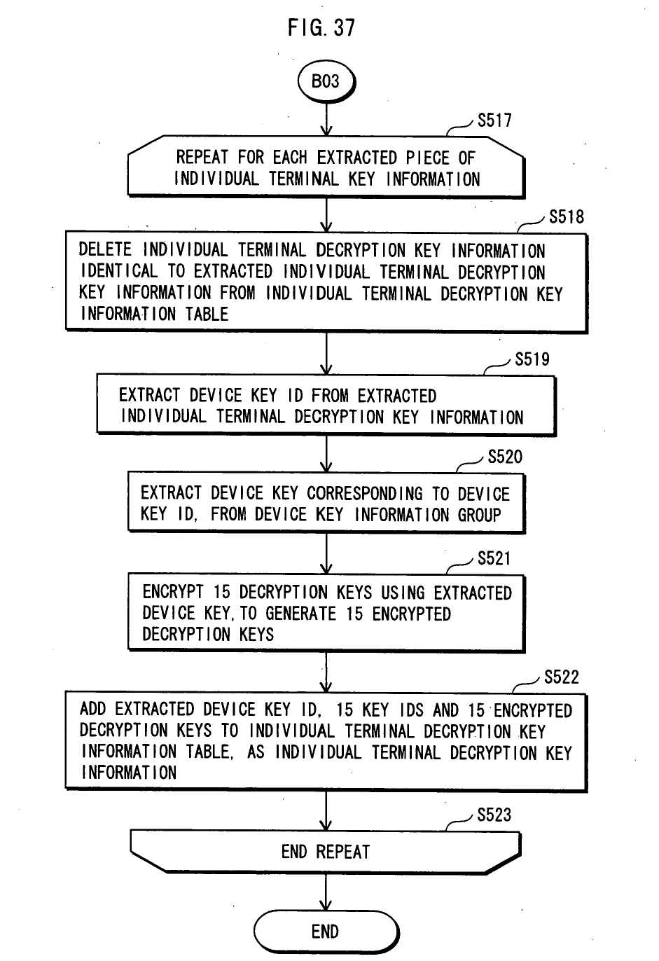

The re-formation unit 204 operates according to the steps shown in the flowchart shown in FIG. 34 to FIG. 37, instead of the steps shows in FIG. 9 to FIG. 13. The re-formation unit 204 is described giving a specific example.

The re-formation unit 204 receives a WM set from the unauthorized terminal receiving unit 202 (step S501). As one example, the received WM set is {“A-2”, “B-3”, . . . , “O-3”}.

(Group Division)

Upon receiving the WM set, the re-formation unit 204 extracts WM information included in a WM set that is identical to the received WM set from WM table 217 in the information storage unit 201 (step S502). As one example, in the WM table 217 shown in FIG. 5, the WM information that includes the WM set identical to the received WM set {“A-2”, “B-3”, . . . , “O-3”} is the WM set that includes the key ID set {“0xF221”, “0xF222”, . . . , “0xF22F”}.

Next, the re-formation unit 204 extracts the key ID set composed of 15 key IDs (division target key ID set) from the extracted WM information, and extracts the piece of individual terminal decryption key information that includes an identical key ID set to the extracted key ID set, from the individual terminal decryption key information table 821 (step S503). As one example, the key ID set {“0xF221”, “0xF222”, . . . , “0xF22F”} is extracted from the extracted WM information, and the piece of individual terminal decryption key information 831 and 832 that include a key ID set identical to the extracted key ID set are extracted. As shown in FIG. 33, the individual terminal decryption key information 831 and 832 both include the set of key IDs {“0xF221”, “0xF222”, . . . , “0xF22F”}.

Next, at step S504 to step S512, the re-formation unit 204 repeats steps S505 to step S511 for each extracted piece of individual terminal decryption key information. As one example, step S505 to step S511 are repeated for the individual terminal decryption key information 831 and 832. The following uses the individual terminal decryption key information 831 as an example.

The re-formation unit 204 deletes a piece of individual terminal decryption key information identical to the extracted piece of individual terminal decryption key information from the individual terminal decryption key information table 821 (step S505). As one example, the individual terminal decryption key information 831 is deleted from the individual terminal decryption key information table 821.

Next, the re-formation unit 204 newly generates 15 unique key IDs (step S506). As one example, the generated 15 key IDs are the key IDs “0xE551”, “0xE552”, . . . , “0xE55F” included in the individual terminal decryption key information 841 in the individual terminal decryption key information table 821a shown in FIG. 33.

Next, the re-formation unit 204 generates 15 random numbers, and newly generates 15 decryption keys by making these random numbers the decryption keys (step S507). An example of the 15 generated decryption keys is the decryption keys Ks₅₀₁, Ks₀₅₀₂, . . . , Ks₀₅₁₅ shown in the individual terminal decryption key information 841 in the individual terminal decryption key table 821a shown in FIG. 33.

Next, the re-formation unit 204 extracts the device key ID from the extracted piece of individual terminal decryption key information (step S508). As one example, the device key ID “0x0000001D” is extracted from the extracted individual terminal decryption key information 831.

Next, the re-formation unit 204 extracts the device key corresponding to the extracted device key ID from the device key information group 800 (step S509). As one example, the device key “0x11 . . . 11” corresponding to the device key ID “0x0000001D” is extracted.

Next, the re-formation unit 204 encrypts each of the 15 generated decryption keys with use of the extracted device key, thereby generating 15 encrypted decryption keys (step S510). As one example, the extracted device key is “0x11 . . . 11”. For brevity, this device key is expressed as Kdev₁ in the individual terminal decryption key table 821a shown in FIG. 33. The 15 generated encrypted decryption keys are E (Kdev₁, Ks₀₅₀₁), E (Kdev₁, Ks₀₅₀₂), . . . , E(Kdev₁, Ks₀₅₁₅).

Next, the re-formation unit 204 adds the extracted device key ID, the generated 15 key IDs, and the generated 15 encrypted decryption keys to the individual terminal decryption key information table 821 as a piece of individual terminal decryption key information. Here, the 15 key IDs and the 15 encrypted decryption keys are put in correspondence (step S511). As one example, the individual terminal decryption key information 841 is written to the individual terminal decryption key information table 821a shown in FIG. 33.

As one example, step S505 to step S511 are also repeated from the individual terminal decryption key information 832, and the individual terminal decryption key information 842 is written to the individual terminal decryption key information table 821a shown in FIG. 33.

According to the described processing, as one example, the individual terminal decryption key information 841 and 842 are recorded in the individual terminal decryption key information table 821a shown in FIG. 33, instead of the individual terminal decryption key information 831 and 832 in the individual terminal decryption key information table 821 shown in FIG. 33.

Furthermore, as one example, the 15 decryption keys that are the basis of the 15 encrypted decryption keys included in the individual terminal decryption key information 831 are respectively identical to the 15 decryption key that are the basis of the 15 encrypted decryption keys included in the individual terminal decryption key information 832.

However, after the group division, the 15 decryption keys that are the basis of the 15 encrypted decryption keys included in the individual terminal decryption key information 841 are respectively different to the 15 decryption keys that are the basis of the 15 encrypted decryption keys included in the individual terminal decryption key information 842.

In this way, as shown in FIG. 31, the playback terminals 701 and 702 that belonged to the same group 711 in the group structure 731 belong to different groups, namely groups 721 and 722, in the group structure 741 as a result of the group division.

Note that the operations at step S502 to step S512 are performed by the division unit 204a in the re-formation unit 204.

(Group Integration)

The re-formation unit 204 extracts, from the individual terminal decryption key information table 821, at least one piece of individual terminal decryption key information that includes a first key ID set that is different from the division target key ID set (step S513). As one example, the individual terminal decryption key information 833 is extracted from the individual terminal decryption key information table 821.

Next, the re-formation unit 204 extracts at least one piece of individual terminal decryption key information that includes a second key ID set that is different from both the division target key ID set and the first key ID set (step S514). As one example, the individual terminal decryption key information 834 is extracted from the individual terminal decryption key information table 821.

Next, the re-formation unit 204 newly generates 15 unique key IDs (step S515). One example of the 15 generated key IDs are the key IDs “0xF771”, “0xF772”, . . . , “0xF77F” included in the individual terminal decryption key information 843 in the individual terminal decryption key information table 821a shown in FIG. 33.

Next, the re-formation unit 204 generates 15 random numbers, and newly generates 15 decryption keys by making the these random numbers the decryption keys (step S516). An example of the 15 generated decryption keys is the decryption keys Ks₀₇₀₁, Ks₀₇₀₂, . . . , Ks₀₇₁₅ shown in the individual terminal decryption key information 843 in the individual terminal decryption key table 821a shown in FIG. 33.

Next, at step S517 to step S523, the re-formation unit 204 repeats step S518 to step S522 for each extracted piece of individual terminal decryption key information. As one example, step S518 to step S522 are repeated for the individual terminal decryption key information 833 and the individual terminal decryption key information 834. The following uses the individual terminal decryption key information 833 as an example.

The re-formation unit 204 deletes the piece of individual terminal key information that is identical to the extracted piece of individual terminal decryption key information, from the individual terminal decryption key information table 821 (step S518). As one example, the individual terminal decryption key information 833 is deleted from the individual terminal decryption key information table 821.

Next, the re-formation unit 204 extracts the device key ID from the extracted piece of individual terminal decryption key information (step S519). As one example, the device key ID “0x4000001D” is extracted from the extracted individual terminal decryption key information 833.

Next, the re-formation unit 204 specifies a piece of device key information corresponding to the extracted device key ID from the device key information group 800, and extracts the specified piece of device key information from the device key (step S520). As one example, the device key “0x33 . . . 31” is extracted from the device key information 803.

Next, the re-formation unit 204 encrypts each of the 15 generated decryption keys with use of the extracted device key, thereby generating 15 encrypted decryption keys (step S521). As one example, the extracted device key is “0x33 . . . 31”. For brevity, this device key is expressed as Kdev₃ in the individual terminal decryption key table 821a shown in FIG. 33. The 15 generated encrypted decryption keys are E(Kdev₃, Ks₀₇₀₁), E (Kdev₃, Ks₀₇₀₂), . . . , E (Kdev₃, Ks₀₇₁₅).

Next, the re-formation unit 204 adds the extracted device key ID, the 15 generated key IDs, and the 15 generated encrypted decryption keys to the individual terminal decryption key information table 821 as a piece of individual terminal decryption key information (step S522). As one example, the individual terminal decryption key information 843 is written to the individual terminal decryption key information table 821a shown in FIG. 33.

According to the described processing, as one example, the individual terminal decryption key information 843 and 844 are recorded in the individual terminal decryption key information table 821a shown in FIG. 33, instead of the individual terminal decryption key information 833 and 834 in the individual terminal decryption key information table 821 shown in FIG. 33.

As one example, the 15 decryption keys used as a basis for the 15 encrypted decryption keys included in the individual terminal decryption key information 833 are respectively different from the decryption keys used a basis for the 15 encrypted decryption keys included in the individual terminal decryption key information 834.

However, as a result of the group division, the 15 decryption keys used as a basis for the 15 encrypted decryption keys included in the individual terminal decryption key information 843 are respectively identical to the 15 decryption keys used as a basis for the 15 encrypted decryption keys included in the individual terminal decryption key information 844.

In this way, as shown in FIG. 31, playback terminals 704 and 706 that belonged to different groups 712 and 713 in the group structure 731 end up belonging to the same group 723 in the group structure 741 as a result of the group integration.

Note that the operations at steps S513 to S514 are performed by the selection unit 204b in the re-formation unit 204, and the operations at steps S515 to S522 are performed by the integration unit 204c in the re-formation unit 204.

### 3. Other Modifications

Although the present invention has been described based on the above preferred embodiment, the present invention is by no means limited to the described embodiment. Cases such as the following are included in the present invention.

(1) Although the above embodiment is described on the assumption that the number of content stored on one BD is one, a plurality of content may be recorded on one BD. In this case, a terminal-use playback information table, playback control information, individual terminal decryption key information tables, encrypted general clip data and encrypted tracing clip data must be recorded for each content. It is possible, however, for these to be shared by the plurality of content.

The present invention is a recording medium that stores content data thereon, the recording medium having stored thereon: encrypted divisional data generated by dividing the content data into a plurality of pieces of divisional data, embedding a watermark in some of the pieces of divisional data as unique information, and then encrypting the plurality pieces of divisional data with device keys held by playback apparatuses; device-use playback information specifying a device key uniquely for the playback apparatus; and playback control information defining a playback order of the plurality of pieces of divisional data in a playback apparatus having the device key.

Here, the device key may be a device key shared by a plurality of playback apparatuses.

Here, the device key may be a device key that is unique to the playback apparatus.

Furthermore, the present invention is a content playback apparatus that, in accordance with a designated order, decrypts and plays a plurality of pieces of encrypted divisional data recorded on a recording medium, the content playback apparatus including: a unit operable to hold a plurality of playback-use device keys for playing encrypted divisional data.

Here, the playback apparatus may further include: a unit operable to hold a device key unique to the playback apparatus, as one of the playback-use device keys.

Here, the playback apparatus may further include: a unit operable to hold the playback-use device keys that are playback-use device keys held by a plurality of playback use apparatuses.

Here, the playback apparatus may further include: a unit operable to hold the playback-use device keys as information common with a revocation-use device key used for revoking an unauthorized terminal.

Here, the playback apparatus may further include: a unit operable to determine a device key to use in decryption, from device-use playback information recorded on the recording medium; and a playback control information determination unit operable to determine playback control information corresponding to the determined device key.

Furthermore, the present invention is a content playback method that, in accordance with a designated order, decrypts and plays a plurality of pieces of encrypted divisional data recorded on a recording medium, the content playback method including: a step of checking whether information that matches a device key held by a playback apparatus is included in device-use playback information recorded on the recording medium, and when matching information exists, determining the matching device key to be a playback-use device key; and a step of decrypting and playing encrypted data in accordance with an order written in playback control information corresponding to the playback-use device key.

Furthermore, the present invention is a program that causes a computer to execute said steps.

Furthermore, the present invention is a computer-readable recording medium that stores thereon a program for causing the said steps to be executed.

(3) In the described embodiment, as shown as one example in FIG. 7, the division unit 204a in the re-formation unit 204 divides the group 228, which the playback apparatus associated with unauthorized usage belongs to, into two groups, namely the group 232 and the group 233. Here, since the tree structures 221 and 231 are binary trees, one playback apparatus belongs to each of the newly formed groups 232 and 233.

Since the original group to which the playback apparatus associated with unauthorized usage belongs is divided into two groups, and each of the two groups has one playback apparatus belonging thereto, when the playback apparatus associated with unauthorized usage is again used in an unauthorized manner and a recording medium produced by unauthorized copying is distributed, the group to which only the playback apparatus associated with unauthorized usage belongs can be specified. In other words, this enables the playback apparatus relating to authorized usage to be specified.

Here, the tree structure is not limited to being a binary tree, and a ternary tree, for instance, may be used. In the case of a ternary tree, the division unit 204a in the re-formation unit 204 divides the group to which the playback apparatus relating to unauthorized use belongs into three groups. Here, since the tree structure is a ternary tree, each of the newly formed groups has one playback apparatus belonging thereto. In this case also, since the original group to which the playback apparatus associated with unauthorized usage belonged has been divided into three groups with one playback apparatus belonging to each group, next when the playback apparatus associated with unauthorized usage is again used in an unauthorized manner, and a recording medium produced by unauthorized copying is distributed, the group to which only the playback apparatus associated with unauthorized usage belongs can be specified in the same way as with the binary tree. In other words, this enables the playback apparatus associated with unauthorized usage to be specified.

Generally, an n-ary tree may be used. Here, n is an integer of two or greater. In this case also, the division unit 204a of the re-formation unit 204 may divide the group to which the playback apparatus associated with unauthorized usage belongs into n groups in the described manner. In other words, the division unit 204a divides playback apparatuses belonging to the one group into separate groups consisting of one playback apparatus each.

(4) Although the above modification describes the division unit 204a in the re-formation unit 204 as dividing the group to which the playback apparatus associated with unauthorized usage belongs into n groups, the division unit 204a is not limited to doing this.

For instance, when using a 4-ary tree, the division unit 204a of the re-formation unit 204 may divide the group to which the playback apparatus associated with unauthorized usage belongs into two groups. In this case, since the original group to which the playback apparatus associated with unauthorized usage belonged is divided into two groups, each of the two groups will have two playback apparatuses belonging thereto.

Next, when the playback apparatus associated with unauthorized usage is again used for unauthorized usage and a recording medium is produced by unauthorized copying, the group to which the playback apparatus associated with unauthorized usage belongs can be specified. In other words, even if the playback apparatus associated with unauthorized usage cannot be specified directly, since the number of playback apparatuses belonging to the new group is less that the number of playback apparatuses that belonged to the original group, it will be easier to find the playback apparatus associated with unauthorized usage.

(5) In the described embodiment, the selection unit 204b in the re-formation unit 204 selects the two groups 229 and 230 as shown as one example in FIG. 7, and the integration unit 204c integrates the selected two groups into one group 234. However, the number of integration target groups is not limited to being two.

The selection unit 204b may select three or more groups that do not include the playback apparatus associated with unauthorized usage, and the integration unit 204c may integrate the selected three or more groups to form one group.

Furthermore, the selection unit 204b may select three or more groups that do not include the playback apparatus associated with unauthorized usage, and the integration unit 204c may select, for instance, two of the selected groups and integrate to selected two groups, thereby generating one group. In other words, the integration unit 204c may integrate the selected groups to generate one group or groups whose total number is less than the selected number of groups.

(6) When selecting groups as an integration target, the selection unit 204b in the re-formation unit 204 may select at least one group that has a total number of playback apparatuses belonging thereto that is less than a predetermined number. Take for instance a case of division and integration becoming necessary again in the tree structure 231 shown in FIG. 7. Since four playback apparatuses belong to the group 234, if the predetermined number is “4” for instance, the selection unit 204b may select groups having less than four apparatuses belonging thereto, not the group 234, and integrate these selected groups.

This kind of structure means that the number of playback apparatuses belonging to the group newly formed by integration can be made relatively low.

If the number of playback apparatuses belonging to a group is relatively low, it will be easier to specify a playback apparatus used in an unauthorized manner if such a playback apparatus belongs to the group.

(7) In the described embodiment, the selection unit 204b in the re-formation unit 204 selects the group 229 and the group 230 as integration target groups as shown in FIG. 7. The groups 229 and 230 derive from the same node, and therefore are mutually related to each other.

In this way, the selection unit 204b of the re-formation unit 204 selects groups that have are mutually related to each other. The selection unit 204b may select groups that are even more closely related to each other.

(8) Although the content is described as being distributed recorded on a BD in the described embodiment, the recording medium is not limited to being a BD. The content may be distributed recorded on another type of optical disc, or on a semiconductor memory, or a small hard disk recording apparatus.

Furthermore, the content may be distributed via a network, the Internet being representative of such a network, or may be distributed by being broadcast according to digital broadcasting.

(9) Although the manufacturing apparatus 300 writes information to the BD in the described embodiment, the present invention is not limited to this structure.

The management server apparatus 200 and the manufacturing apparatus 300 may be a single apparatus. In other words, the output unit 205 of the management server apparatus 200 may be composed of a media key generation unit, a media key encryption unit, a control unit, a clip key encryption unit, a content generation unit, and a writing unit (not illustrated).

The media key generation unit generates a media key composed of a portion unique to a recording medium and a portion unique to a content playback apparatus.

The media key encryption unit encrypts the generated media key using a device key allocated to the content playback apparatus, thereby generating an encrypted media key.

The control unit controls the media key generation unit so as to generate a media key for each of content playback apparatuses, and controls the media key encryption unit so as to generate encrypted media keys. This results in a media key group that includes a plurality of encrypted media keys being generated.

The clip key encryption unit encrypts a tracing clip key using the media key, thereby generating an encrypted tracing clip key.

The content generation unit uses the tracing clip key to encrypt a tracing clip in which tracing information has been embedded as a digital watermark, thereby generating an encrypted tracing clip, and generates encrypted content that includes the generated encrypted tracing clip in correspondence with the playback apparatus.

The writing unit writes the generated media key group, encrypted tracing clip key, and the encrypted content on a recording medium.

Furthermore, the manufacturing apparatus 300 may be composed of the media key generation unit, the media key encryption unit, the control unit, the clip key encryption unit, the content generation unit, and the writing unit.

(10) In the described embodiment, the recording apparatus 500 converts an analog video signal and audio signal received from a playback apparatus 100b into digital video information and audio information, compression encodes and encrypts the video information and audio information to generate encrypted content, and writes the encrypted content to the BD 650a. However, the recording apparatus 500 is not limited to this structure.

(a) The recording apparatus 500 may convert the analog video signal and audio signal received from the playback apparatus 100b into digital video information and audio information, compression encode the video information and audio information to generate content, and write the generated content to the BD 650a.

In this case, the inspection apparatus 400 reads the content from the BD 650a, expands the content, extracts the audio information therefrom, converts the extracted audio information into an analog audio signal, and extracts the WM set from the analog audio signal.

Furthermore, the recording apparatus 500 may convert the analog video signal and audio signal received from the playback apparatus 100b into digital video information and audio information, generate content composed of the digital video information and audio information, and write the generated content to the BD 650a.

In this case, the inspection apparatus 400 reads the content from the BD 650a, extracts the digital audio information from the read content, converts the extracted audio information into an analog audio signal, and extracts the WM set from the analog audio signal.

Furthermore, the recording apparatus 500 may write the received analog video signal and audio signal to an analog recording medium such as a magnetic tape, instead of writing to a BD.

In this case, the inspection apparatus 400 extracts the analog audio signal from the analog recording medium, and extracts the WM set from the extracted analog audio signal.

(b) The recording apparatus 500 may convert the analog video signal and audio signal received from the playback apparatus 100b into digital video information and audio information, compression encode and encrypt the video information and audio information to generate encrypted content, and transmit the encrypted content via a network of which Internet is representative. In this way, the encrypted content is distributed over the network.

In this case, the inspection apparatus 400 receives the encrypted content via the network, decrypts the encrypted content to generate decrypted content, expands the generated decrypted content and extracts the audio information therefrom, converts the extracted audio information into an analog audio signal, and extracts the WM set from the analog audio signal.

Furthermore, the recording apparatus 500 may convert the analog video signal and audio signal received from the playback apparatus 100b into digital video information and audio information, compression encode the video information and audio information to generate content, and transmit the generated content via a network of which the Internet is representative.

In this case, the inspection apparatus 400 receives the content via the network, expands the received content and extracts the digital audio information, converts the extracted audio information into an analog audio signal, and extracts the WM set from the analog audio signal.

Furthermore, the recording apparatus 500 may convert the analog video signal and audio signal received from the playback apparatus 100b into digital video information and audio information, generate content composed of the digital video information and audio information, and transmit the generated content via a network of which the Internet is representative.

In this case, the inspection apparatus 400 receives the content via the network, extracts the digital audio information from the received content, converts the extracted audio information into an analog audio signal, and extracts the WM set from the analog audio signal.

(11) Although in the described embodiment the 5-level binary tree structure 221 shown as one example in FIG. 7 is a 5-level tree structure, the number of levels in the tree structure is not limited to being five. Generally, an m-layer tree structure may be used. Here, in is an integer of two or greater. Furthermore, an n-level n-ary tree structure may be used.

(12) In the above embodiment, as shown as one example in FIG. 7, the division unit 204a in the re-formation unit 204 divides the group 228 to which the playback apparatus associated with unauthorized usage belongs into two groups 232 and 233, and each of the newly formed groups 232 and 233 has one playback apparatus belonging thereto. However, the present invention is not limited to this structure, and may be as follows.

When, for instance, a playback apparatus associated with unauthorized usage is detected and a first group to which the playback apparatus associated with unauthorized usage belongs (e.g., a group of eight playback apparatuses) is divided, instead of dividing each playback apparatus into a separate group, the plurality of playback apparatuses from the group to which the playback apparatus associated with unauthorized usage belongs may be divided such that each newly formed group has more than one playback apparatus. Here, assume for instance that a second group is newly generated, and that four playback apparatuses including the playback apparatus associated with unauthorized usage belong to this second group. The playback apparatuses are managed according to these newly formed groups.

When the playback apparatus associated with unauthorized usage is next detected, the division unit 204a of the re-formation unit 204 may further divide the group to which playback apparatus associated with unauthorized usage belongs such that a plurality of playback apparatuses belong to each newly formed group. Here, assume for instance that a third group is generated, and that two playback apparatuses including the playback apparatus associated with unauthorized usage belong to this third group.

When the playback apparatus associated with unauthorized usage is subsequently detected again, the division unit 204a of the re-formation unit 204 further divides the third group to which the playback apparatus associated with unauthorized usage belongs into groups of one playback apparatus. Here, a third group is newly generated, and only the playback apparatus associated with unauthorized usage belongs to this third group.

When the playback apparatuses are managed with a tree structure as in the described embodiment, the described division (refinement) may be realized by, each time a playback apparatus associated with unauthorized usage is detected, dividing the group that it belongs to into groups expressed by subtrees whose respective roots are the nodes one level below.

Note that the group division may be performed by selecting groups that are not related in terms of the level of the root.

This method of realizing division is particularly effective when an extremely large number of playback apparatuses belong to the group to which the playback apparatus associated with unauthorized usage belongs.

That is, by dividing such that only one playback apparatus belongs to the group to which the playback apparatus associated with unauthorized usage belongs, the number of divisional group will be extremely large, and cause an increase in the number of types of tracing clip data. As a result, the size of the content will increase, and potentially cause an increase in the number of recording mediums used to store the content, and difficulties in distributing the content over the network.

In contrast, if the described method of realizing division is used to divide groups in stages, and remaining groups are integrated each time division is performed, the number of groups can be kept within a range that is close to the number of groups in the initial state, and increases in the size of content due to an explosive increase in the number of groups can be prevented.

Furthermore, if the group to which the playback apparatus associated with unauthorized usage belongs is made smaller each time division occurs, the playback apparatus associated with unauthorized usage can ultimately be specified.

(13) Although a watermark is described as being embedded in an analog audio signal in the described embodiment, the watermark is not limited to being embedded in the audio signal. The watermark may, for instance, be embedded in an analog video signal, a digital video signal, or a digital audio signal used as a basis to generate the content.

(14) Each described apparatus is, specifically, a computer system composed of a microprocessor, a ROM, a RAM, a hard disk unit, a display unit, a keyboard, a mouse, and the like. A computer program is stored in the RAM or the hard disk unit. The computer program is composed of a plurality of instruction codes showing instructions with respect to a computer in order to have predetermined functions achieved. Each apparatus achieves predetermined functions by the microprocessor operating according to the computer programs. In other words, the microprocessor reads one of the instructions included in the computer program at a time, decodes the read instruction, and operates in accordance with the result of the decoding.

(15) All or part of the compositional elements of each apparatus may be composed of one system LSI (Large Scale Integrated circuit). The system LSI is a super-multifunctional LSI on which a plurality of compositional units are manufactured integrated on one chip, and is specifically a computer system that includes a microprocessor, a ROM, a RAM, or the like. A computer program is stored in the RAM. The system LSI achieves its functions by the microprocessor operating according to the computer program.

Furthermore, the units that are the compositional elements of each of the apparatuses may be realized separately with individual chips, or part or all may be included on one chip. Here, the LSI may be an IC, a system LSI, a super LSI, or ultra LSI, depending on the degree of integration.

Furthermore, the integration of circuits is not limited to being realized with LSI, but may be realized with a special-purpose circuit or a general-use processor. Alternatively, the integration may be realized with use of a FPGA (field programmable gate array) that is programmable after manufacturing of the LSI, or a re-configurable processor that enables re-configuration of the connection and settings of circuit cells in the LSI.

Furthermore, if technology for an integrated circuit that replaces LSIs appears due to advances in or derivations from semiconductor technology, that technology may be used for integration of the functional blocks. Bio-technology is one possible application.

(16) Part or all of the compositional elements of each apparatus may be composed of a removable IC card or a single module. The IC card or the module is a computer system composed of a microprocessor, a ROM, a RAM, or the like. The IC card or the module may be included the aforementioned super-multifunctional LSI. The IC card or the module achieves its functions by the microprocessor operating according to computer program. The IC card or the module may be tamper-resistant.

(17) The present invention may be methods shown by the above. Furthermore, the methods may be a computer program realized by a computer, and may be a digital signal of the computer program.

Furthermore, the present invention may be a computer-readable recording medium such as a flexible disk, a hard disk, a CD-ROM, an MO, a DVD, a DVD-ROM, a DVD-RAM, a BD (Blu-ray Disc) or a semiconductor memory, that stores the computer program or the digital signal. Furthermore, the present invention may be the computer program or the digital signal recorded on any of the aforementioned recording media.

Furthermore, the present invention may be the computer program or the digital signal transmitted on a electric communication network, a wireless or wired communication network, a network of which the Internet is representative, or a data broadcast.

Furthermore, the present invention may be a computer system that includes a microprocessor and a memory, the memory storing the computer program, and the microprocessor operating according to the computer program.

Furthermore, by transferring the program or the digital signal to the recording medium, or by transferring the program or the digital signal via a network or the like, the program or the digital signal may be executed by another independent computer system.

(18) The present invention may be any combination of the above-described embodiment and modifications.

(19) As has been described, according to the present invention, all terminals are grouped in accordance with the number of combinations of embedded watermarks, and a group that includes an unauthorized terminal is specified from the combination watermarks embedded in the content. When the group that includes the unauthorized terminal is specified, the group is divided, and groups that do not include the unauthorized terminal are integrated. This enables the unauthorized terminal to be specified while the amount of data recorded on the recording medium is kept within the capacity of the recording medium.

The information recording medium, playback apparatus, and content playback method having a data structure for specifying an unauthorized terminal that is the distribution source using watermark information embedded in the content distributed without authorization are effective in various fields such as the field of packaged media.

### INDUSTRIAL APPLICABILITY

The recording medium and apparatuses of the present invention can be used managerially, in other words, repeatedly and continuously, in a content distribution industry in which content is created and distributed. The recording medium and apparatuses of the present invention can be manufactured and sold managerially, in other words, repeatedly and continuously, in an electrical device industry.

1. A management server apparatus that manages a plurality of terminal apparatuses that play a content, and, with use of groups to which the plurality of terminal apparatuses belong, specifies a terminal apparatus associated with unauthorized usage of the content, the unauthorized usage being unauthorized distribution, the management server apparatus comprising:
a holding unit operable to hold the plurality of groups to which the one or more terminal apparatuses belong;
an acquisition unit operable to acquire a designation of a target group to which the terminal apparatus associated with unauthorized usage belongs;
a division unit operable to divide the designated target group into (i) a divisional group to which the terminal apparatus associated with unauthorized usage belongs, and (ii) at least one divisional group to which a remaining terminal apparatus of the target group belongs;
a selection unit operable to select two or more candidate groups to which the terminal apparatus associated with unauthorized usage does not belong; and
an integration unit operable to integrate the selected candidate groups.

2. The management server apparatus of claim 1, wherein
the selection unit selects the candidate groups such that at least one of the candidate groups includes terminal apparatuses whose total number is less than a predetermined number.

3. The management server apparatus of claim 1, wherein
the selection unit selects the candidate groups that have mutual relation with each other.

4. The management server apparatus of claim 1, wherein
the integration unit integrates the selected candidate groups such that a total number of resultant one or more integrated groups is lower than a total number of the selected candidate groups.

5. The management server apparatus of claim 1, wherein
the holding unit holds the plurality of groups of the terminal apparatuses that have been sorted with use of a tree structure.

6. The management server apparatus of claim 5, wherein
the tree structure is composed of a plurality of nodes arranged in a multi-layer tree shape, each of the terminal apparatuses is allocated to a different one of leaves in the tree structure, and in any given subtree in the tree structure, terminal apparatuses allocated to leaves thereof compose a single group, a subtree being a portion of the tree structure whose root is a given node in the tree structure,
the division unit generates, for each of a plurality of subtrees whose root is a subordinate of a target node corresponding to the target group, a divisional group including one or more terminal apparatuses, each of the terminal apparatuses being allocated to a leaf of the subtree, and replaces the target group with the generated divisional groups,
the selection unit selects a plurality of subordinate nodes that are subordinate to a superordinate node of the target node and exclude the target node, and selects candidate groups corresponding to each of the selected subordinate nodes, and
the integration unit integrates the selected candidate groups into one integrated group.

7. The management server of claim 1, wherein
the holding unit stores a plurality of mutually different decryption keys, each corresponded with a different one of the groups,
the division unit, instead of a decryption key of the designated target group, generates a decryption key for the divisional group to which the terminal apparatus associated with unauthorized usage belongs, and generates a different decryption key for the divisional group to which the remaining terminal of the target group belongs,
the selection unit selects a different decryption key for each candidate group, and
the integration unit generates one decryption key to correspond to the integrated group instead of the different decryption keys for the candidate groups.

8. A recording medium writing apparatus that writes encrypted content to a recording medium, comprising:
a media key generation unit operable to generate a media key that includes a portion unique to the recording medium and a portion unique to a content playback apparatus;
a media key encryption unit operable to encrypt said media key with use of a device key allocated to said content playback apparatus, thereby generating an encrypted media key;
a control unit operable to generate a media key set composed of a plurality of encrypted media keys, the plurality of encrypted media keys being generated by the control unit (a) controlling the media key generation unit so as to generate a media key for each of a plurality of playback apparatuses, and (b) controlling the media key encryption unit so as to generate an encrypted media key for each of the plurality of playback apparatuses;
a clip key encryption unit operable to encrypt a tracing clip key with use of said media key, thereby generating an encrypted tracing clip key;
a content generation unit operable to (a) encrypt a tracing clip with use of the tracing clip key, thereby generating an encrypted tracing clip, the tracing clip having tracing information embedded therein as a digital watermark, and (b) generate encrypted content that includes the generated encrypted tracing clip in correspondence with said content playback apparatus; and
a writing unit operable to write the generated media key set, the encrypted tracing clip data, and the encrypted content to the recording medium.

9. A computer-readable portable recording medium storing thereon
a media key set that is in correspondence with a content playback apparatus and that includes an encrypted media key generated by encrypting a media key with use of a device key, the media key includes a portion unique to the recording medium and a portion unique to the content playback apparatus, and the device key being a device key allocated to the content playback apparatus,
an encrypted tracing clip key generated by encrypting tracing clip key with use of the media key, and
encrypted content that includes an encrypted tracing clip in correspondence with the content playback apparatus, the encrypted tracing clip having been generated by encrypting tracing clip data having tracing information embedded therein as a digital watermark.

10. The recording medium of claim 9, further storing thereon
a predetermined number of encrypted tracing clip keys generated by encrypting, with use of the media key, each one of the predetermined number of mutually different tracing clip keys,
wherein the encrypted content further includes the predetermined number of encrypted tracing clips in correspondence with the content playback apparatus, the encrypted tracing clips having been generated by encrypting each one of the predetermined number of tracing clips with a different one of tracing clip keys, each one of the tracing clips having embedded therein as an electronic watermark, tracing information that is different from tracing information embedded in any other of the tracing clips.

11. The recording medium of claim 10, further storing thereon
at least one encrypted general clip key that has been generated by encrypting at least one general clip key with use of the media key,
wherein the encrypted content further includes a plurality of encrypted general clips in correspondence with the content playback apparatus, the plurality of encrypted general clips having been generated by encrypting each of a plurality of general clips with use of the at least one general clip key.

12. The recording medium of claim 11, further storing thereon
playback order information showing an order of decrypting and playing the encrypted tracing clips and the encrypted general clips in correspondence with the content playback apparatus.

13. A content playback apparatus that decrypts and plays encrypted content stored on the recording medium of claim 9, the content playback apparatus comprising:
a first decryption unit operable to decrypt, with use of a device key allocated to the content playback apparatus, an encrypted media key that is stored on the recording medium in correspondence with the content playback apparatus, thereby generating a decrypted media key;
a second decryption unit operable to decrypt, with use of the generated decrypted media key, an encrypted tracing clip key stored on the recording medium, thereby generating a decrypted tracing clip key;
a third decryption unit operable to decrypt, with use of the generated decrypted tracing clip key, an encrypted tracing clip that is stored on the recording medium in correspondence with the content playback apparatus, thereby generating a decrypted tracing clip; and
a playback unit operable to play the generated decrypted tracing clip.

14. The content playback apparatus of claim 13, that decrypts and plays encrypted content stored on a recording medium storing thereon
a media key set that is in correspondence with a content playback apparatus and that includes an encrypted media key generated by encrypting a media key with use of a device key, the media key includes a portion unique to the recording medium and a portion unique to the content playback apparatus, and the device key being a device key allocated to the content playback apparatus,
an encrypted tracing clip key generated by encrypting tracing clip key with use of the media key.
encrypted content that includes an encrypted tracing clip in correspondence with the content playback apparatus, the encrypted tracing clip having been generated by encrypting tracing clip data having tracing information embedded therein as a digital watermark, and
a predetermined number of encrypted tracing clip keys generated by encrypting, with use of the media key, each one of the predetermined number of mutually different tracing clip keys, wherein the encrypted content further includes the predetermined number of encrypted tracing clips in correspondence with the content playback apparatus, the encrypted tracing clips having been generated by encrypting each one of the predetermined number of tracing clips with a different one of tracing clip keys, each one of the tracing clips having embedded therein as an electronic watermark tracing information that is different from tracing information embedded in any other of the tracing clips, wherein
the second decryption unit further decrypts, with use of the generated decrypted media key, each of the predetermined number of encrypted tracing clip keys stored on the recording medium, thereby generating the predetermined number of decrypted tracing clip keys,
the third decryption unit further decrypts, with use of each of the generated predetermined number of decrypted tracing clip keys, the predetermined number of encrypted tracing clips that are in correspondence with the playback apparatus, thereby generating the predetermined number of decrypted tracing clips, and
the playback unit further plays the generated predetermined number of decrypted tracing clips.

15. The content playback apparatus of claim 14, wherein
the second decryption unit further decrypts, with use of the generated decrypted media key, the at least one encrypted general clip key stored on a recording medium storing thereon
a media key set that is in correspondence with a content playback apparatus and that includes an encrypted media key generated by encrypting a media key with use of a device key, the media key includes a portion unique to the recording medium and a portion unique to the content playback apparatus, and the device key being a device key allocated to the content playback apparatus,
an encrypted tracing clip key generated by encrypting tracing clip key with use of the media key,
encrypted content that includes an encrypted tracing clip in correspondence with the content playback apparatus, the encrypted tracing clip having been generated by encrypting tracing clip data having tracing information embedded therein as a digital watermark,
a predetermined number of encrypted tracing clip keys generated by encrypting, with use of the media key, each one of the predetermined number of mutually different tracing clip keys, wherein the encrypted content further includes the predetermined number of encrypted tracing clips in correspondence with the content playback apparatus, the encrypted tracing clips having been generated by encrypting each one of the predetermined number of tracing clips with a different one of tracing clip keys, each one of the tracing clips having embedded therein as an electronic watermark, tracing information that is different from tracing information embedded in any other of the tracing clips, and
at least one encrypted general clip key that has been generated by encrypting at least one general clip key with use of the media key, wherein the encrypted content further includes a plurality of encrypted general clips in correspondence with the content playback apparatus, the plurality of encrypted general clips having been generated by encrypting each of a plurality of general clips with use of the at least one general clip key, thereby generating at least one decrypted general clip key,
the third decryption unit further decrypts, with use of the generated at least one decrypted general clip keys, the plurality of encrypted general clips stored on the recording medium and in correspondence with the content playback apparatus, thereby generating a plurality of decrypted general clips, and
the playback unit plays the generated plurality of decrypted general clips.

16. The content playback apparatus of claim 15, further comprising:
a control unit operable to control the second decryption unit, the third decryption unit and the playback unit so as to decrypt and play the predetermined number of encrypted tracing clips and the plurality of encrypted general clips in accordance with the playback order information stored on a recording medium storing thereon
a media key set that is in correspondence with a content playback apparatus and that includes an encrypted media key generated by encrypting a media key with use of a device key, the media key includes a portion unique to the recording medium and a portion unique to the content playback apparatus and the device key being a device key allocated to the content playback apparatus,
an encrypted tracing clip key generated by encrypting tracing clip key with use of the media key,
encrypted content that includes an encrypted tracing clip in correspondence with the content playback apparatus, the encrypted tracing clip having been generated by encrypting tracing clip data having tracing information embedded therein as a digital watermark,
a predetermined number of encrypted tracing clip keys generated by encrypting, with use of the media key, each one of the predetermined number of mutually different tracing clip keys, wherein the encrypted content further includes the predetermined number of encrypted tracing clips in correspondence with the content playback apparatus, the encrypted tracing clips having been generated by encrypting each one of the predetermined number of tracing clips with a different one of tracing clip keys, each one of the tracing clips having embedded therein as an electronic watermark, tracing information that is different from tracing information embedded in any other of the tracing clips,
at least one encrypted general clip key that has been generated by encrypting at least one general clip key with use of the media key, wherein the encrypted content further includes a plurality of encrypted general clips in correspondence with the content playback apparatus, the plurality of encrypted general clips having been generated by encrypting each of a plurality of general clips with use of the at least one general clip key, and
playback order information showing an order of decrypting and playing the encrypted tracing clips and the encrypted general clips in correspondence with the content playback apparatus.

17. A management method used in a management server apparatus that manages a plurality of terminal apparatuses that play a content, and, with use of groups to which the plurality of terminal apparatuses belong, specifies a terminal apparatus associated with unauthorized usage of the content, the unauthorized usage being unauthorized distribution, the management server apparatus holding the plurality of groups to which the one or more terminal apparatuses belong, the management method comprising:
an acquisition step of acquiring a designation of a target group to which the terminal apparatus associated with unauthorized usage belongs;
a division step of dividing the designated target group into (i) a divisional group to which the terminal apparatus associated with unauthorized usage belongs, and (ii) at least one divisional group to which a remaining terminal apparatus of the target group belongs;
a selection step of selecting two or more candidate groups to which the terminal apparatus associated with unauthorized usage does not belong; and
an integration step of integrating the selected candidate groups.

18. A computer-use management program used in a computer that manages a plurality of terminal apparatuses that play a content, and to which the plurality of terminal apparatuses belong, specifies a terminal apparatus associated with unauthorized usage of the content, the unauthorized usage being unauthorized distribution the computer holding the plurality of groups to which the one or more terminal apparatuses belong, the management program causing the computer to execute:
an acquisition step of acquiring a designation of a target group to which the terminal apparatus associated with unauthorized usage belongs;
a division step of dividing the designated target group into (i) a divisional group to which the terminal apparatus associated with unauthorized usage belongs, and (ii) at least one divisional group to which a remaining terminal apparatus of the target group belongs;
a selection step of selecting two or more candidate groups to which the terminal apparatus associated with unauthorized usage does not belong; and
an integration step of integrating the selected candidate groups.

19. The management program of claim 18, stored on a computer-readable recording medium.

20. An integrated circuit that manages a plurality of terminal apparatuses that play a content, and, with use of groups to which the plurality of terminal apparatuses belong, specifies a terminal apparatus associated with unauthorized usage of the content the unauthorized usage being unauthorized distribution, the integrated circuit comprising:
a holding unit operable to hold the plurality of groups to which the one or more terminal apparatuses belong;
an acquisition unit operable to acquire a designation of a target group to which the terminal apparatus associated with unauthorized usage belongs;
a division unit operable to divide the designated target group into (i) a divisional group to which the terminal apparatus associated with unauthorized usage belongs, and (ii) at least one divisional group to which a remaining terminal apparatus of the target group belongs;
a selection unit operable to select two or more candidate groups to which the terminal apparatus associated with unauthorized usage does not belong; and
an integration unit operable to integrate the selected candidate groups.

21. A content playback method used in a content playback apparatus that decrypts and plays an encrypted content stored on the recording medium of claim 9, the content playback method comprising:
a first decryption step of decrypting, with use of a device key allocated to the content playback apparatus, an encrypted media key that is stored on the recording medium in correspondence with the content playback apparatus, thereby generating a decrypted media key;
a second decryption step of decrypting, with use of the generated decrypted media key, an encrypted tracing clip key stored on the recording medium, thereby generating a decrypted tracing clip key;
a third decryption step of decrypting, with use of the generated decrypted tracing clip key, an encrypted tracing clip that is stored on the recording medium in correspondence with the content playback apparatus, thereby generating a decrypted tracing clip; and
a playback step of playing the generated decrypted tracing clip.

22. A computer-use content playback program used in a computer that decrypts and plays an encrypted content stored on the recording medium of claim 9, the content playback program comprising:
a first decryption step of decrypting, with use of a device key allocated to the content playback apparatus, an encrypted media key that is stored on the recording medium in correspondence with the content playback apparatus, thereby generating a decrypted media key;
a second decryption step of decrypting, with use of the generated decrypted media key, an encrypted tracing clip key stored on the recording medium, thereby generating a decrypted tracing clip key;
a third decryption step of decrypting, with use of the generated decrypted tracing clip key, an encrypted tracing clip that is stored on the recording medium in correspondence with the content playback apparatus, thereby generating a decrypted tracing clip; and
a playback step of playing the generated decrypted tracing clip.

23. The content playback program of claim 22, stored on a computer-readable recording medium.

24. An integrated circuit that decrypts and plays encrypted content stored on the recording medium of claim 9, the integrated circuit comprising:
a first decryption unit operable to decrypt, with use of a device key allocated to the content playback apparatus, an encrypted media key that is stored on the recording medium in correspondence with the content playback apparatus, thereby generating a decrypted media key;
a second decryption unit operable to decrypt, with use of the generated decrypted media key, an encrypted tracing clip key stored on the recording medium, thereby generating a decrypted tracing clip key;
a third decryption unit operable to decrypt, with use of the generated decrypted tracing clip key, an encrypted tracing clip that is stored on the recording medium in correspondence with the content playback apparatus, thereby generating a decrypted tracing clip; and
a playback unit operable to play the generated decrypted tracing clip.
